(19) United States
(12) Patent Application Publication
(10) Pub. No.: US 2018/0249853 A1
(43) Pub. Date: Sep. 6, 2018

(54) Cold Cup Sleeve

(71) Applicant: LBP Manufacturing LLC, Cicero, IL (US)

(72) Inventors: Thomas Z. Fu, Naperville, IL (US); Pazam Subramanian, Chicago, IL (US)

(21) Appl. No.: 15/902,789

(22) Filed: Feb. 22, 2018

Related U.S. Application Data
(60) Provisional application No. 62/462,147, filed on Feb. 22, 2017.

(51) Int. Cl. A47G 23/02; B65D 81/38; B65D 25/36; B32B 1/08; B32B 7/12; B32B 29/08; B32B 27/06; B32B 37/12; B32B 37/06; B32B 38/00

(52) U.S. Cl. CPC A47G 23/0216; B32B 2333/04; B65D 25/36; B32B 1/08; B32B 7/12; B32B 29/08; B32B 27/06; B32B 37/12; B32B 37/06; B32B 38/0004; B32B 2250/02; B32B 2255/12; B32B 2325/00; B32B 2327/06; B32B 2377/00; B65D 81/3886

(57) ABSTRACT

A sleeve for being positioned about the outside surface of a container, such as a beverage container or cup, for absorbing or collecting condensate disposed on the outside surface of the container to inhibit condensate from pooling at the base of the container, as well as to keep condensate from coming into contact with a user. In one form, the sleeve is configured to absorb the condensate with an absorbent material. In other forms, the sleeve has a non-absorbent inner surface that includes entrapment features for collecting, trapping, or dispersing condensate without absorbing the condensate. In some forms, the sleeve is provided with both absorbent and non-absorbent materials. The sleeve is formed with one or more layers of material, such as paper or polymer film.

### CROSS-REFERENCE TO RELATED APPLICATION

This application claims the benefit of U.S. Provisional Patent Application No. 62/462,147, filed Feb. 22, 2017, titled “Cold Cup Sleeve”, which is hereby incorporated by reference in its entirety.

### BACKGROUND

Sleeves or wraps for positioning around a beverage container, such as a paper or plastic cup, are known. When used with hot beverages, the sleeve is used primarily for protecting a user's hand against excessive exposure to the heat emanating from the container and secondarily to insulate the container to prolong the initial serving temperature of the beverage. In the case of cold beverages, the use of a sleeve has primarily been to insulate the container to prolong the initial serving temperature and secondarily to protect the user's hand from exposure to a cold beverage container surface. Cold beverages such as iced coffee, tea, and the like, are commonly dispensed in single-use plastic cups by coffee shops, restaurants, markets, and convenience stores. Even in these temperature-controlled environments, condensation will form and collect on the outer surface of the cup. This condensation, is commonly known as “sweating”, and when the cold beverage and cup are removed to an outside, summer environment, the sweating is greatly increased such that large droplets of sweat will collect and trickle down the outside surface of the cup. Sweating may result in pooling of the condensation at the base of the cup and onto whatever surface the cup is placed upon, or it may drip from the surface of the cup directly onto some part of the consumer or onto an article that the consumer does not want to get wet, such as paperwork or pages of a book. In addition, iced beverages, regardless of whether they are contained in a can, bottle or plastic cup, can become uncomfortable for a user to hold with a bare hand for an extended period of time. Accordingly, with hot beverage applications, where the beverage is usually served in a paper cup, it is known to use cup sleeves to protect the user's hand form the heat being transferred from the beverage to the outside surface of the cup. These types of cup sleeves are commonly made out of paperboard having a corrugated inner layer bonded to one or more flat outer layers. Paper is the preferred choice of materials since it is cost effective and since there is no sweat being generated from a hot beverage which can damage the integrity of the paper sleeve. However, with most cold beverage applications, the cold beverage is often contained and served within an aluminum can or glass bottle and the use of a sleeve has been primarily to insulate the container in order to keep the beverage colder for longer periods of time. In those applications, the sleeve is typically constructed of a bottom member integrally connected to a sidewall member such that both members envelop most of the container structure. This type of insulative sleeve is commonly known as a “koozie.” Koozies are usually made from a foam or foam rubber that has very good insulative properties and which is not destroyed or affected by the generation of condensate on the surface of the beverage container. However, when a cold beverage is served in a plastic or paper cup, the use of a koozie has not found acceptance because the koozie sleeve is not intended to be thrown away along with the plastic or paper cup. Likewise, sleeves made of a paper material are not typically used as an insulator when a cold or iced beverage is served in a plastic or paper cup because the paper sleeve will absorb the condensation formed on the cup surface causing the sleeve to lose structural integrity and insulative effectiveness.

One attempt to address the condensate problem associated with cold or iced beverages that are served in plastic cups is disclosed in U.S. Publication 2005/0121457 to Wilson et al. Wilson discloses a typical paper-based hot cup sleeve for use in a cold beverage application to absorb the condensate generated on the surface of a beverage container. However, one shortfall of that approach is that the disclosed absorbent layer laminated onto the paper-based sleeve would directly wick the absorbed condensate into the paper-based substrate. It is believed that the sleeves disclosed in Wilson would disintegrate and fall apart as a result of the paper substrate becoming over-saturated with water condensate.

Applicants are unaware of a commercially available recyclable cold cup sleeve effective to insulate the user's hand from excess coldness and to substantially collect all of the condensation that forms on a cup, and particularly for a period of 30 minutes or longer while maintaining sufficient structural integrity.

Another issue with cup sleeves made of paperboard material is that they are opaque, which inhibits a user from viewing the beverage through the cup wall, particularly in the case of transparent cups that are often used for serving cold and iced beverages. Studies have found that many users wish to view the rather expensive beverage they purchased, not only to see the amount of beverage remaining in the container, but just to delight in viewing the appearance of the beverage, such as the color, texture, etc. These aesthetic concerns can make the use of paperboard sleeves for use with cold beverages less desirable. Thus, a cold cup sleeve which can absorb, collect or otherwise mitigate the condensate generated on the outer surface of a cup which contains a cold or iced beverage while maintaining a sufficient amount of structural integrity is desirable. There is also a desire for such a sleeve that can offer the user the opportunity to observe his beverage through the sleeve itself if the beverage container is made of a see-through material. There is also a need for a cold beverage sleeve that is either recyclable or compostable for sustainable foodservice packaging applications.

### BRIEF DESCRIPTION OF THE DRAWINGS

FIG. 1 is a plan view of a sleeve blank in accordance with one embodiment of the invention for absorbing condensate generated on the surface of a plastic cold beverage container.

FIG. 2 is a plan view of a corrugated sleeve blank according to another embodiment of the invention showing bands of an absorbent material laid over the upper and lower extents of the sleeve prior to final manufacture.

FIG. 3 is a plan view of a sheet of separably connected sleeve blank of the type shown in FIG. 2 illustrating one method of applying an absorbent material to a plurality of blanks.

FIG. 4 is a perspective view of the sleeve of FIG. 2, shown in a final, assembled state.

FIG. 5 is a plan view of an alternative sleeve configuration having an integrated bottom or coaster portion.

FIG. 6 is a perspective view of the sleeve of FIG. 5 showing the interior of the sleeve.

FIG. 7 is a perspective view of the sleeve in FIG. 2 with an alternative absorbent material.

FIG. 8 is perspective view of the sleeve of FIG. 7 in a compact, folded orientation.

FIG. 9 is a perspective view of a transparent beverage cup containing an iced beverage.

FIG. 10 is a perspective view of a transparent sleeve blank positioned about the cup shown in FIG. 9 in accordance with another embodiment of the invention which traps condensate on the surface of a plastic cold beverage container rather than absorbing it.

FIG. 11 is an enlarged view of the sleeve and cup of FIG. 10.

FIG. 12 is a plan view of an alternative embodiment of a sleeve illustrating an alternative entrapment pattern for trapping condensation.

FIG. 13 is a perspective view of an alternate transparent sleeve positioned about the cup of FIG. 9.

FIG. 14A is a perspective view of the inner surface of the sleeve of FIG. 13.

FIG. 14B is a partial isometric view of an alternative transparent sleeve having entrapment features for collecting and capturing condensate.

FIG. 14C is a plan view of an alternate sleeve having a variety of entrapment features formed by embossing a paper-based substrate.

FIG. 14D is a section view through the line 14D illustrated in FIG. 14C.

FIG. 15 is another embodiment of the invention where a paperboard sleeve is coupled with an inner film layer having an alternative honeycomb pattern for collecting condensation.

FIG. 16 is an enlarged view of one section of the sleeve blank of FIG. 15.

FIG. 17 is a side view of one part of the edge of the sleeve of FIG. 15.

FIG. 18A is a perspective view of a cup sleeve including an expandable section.

FIG. 18B is a cross sectional view through the sleeve of FIG. 18A showing how a section of an expandable material can be attached to the paper substrate of the sleeve.

FIG. 18C is a perspective view of another embodiment of a cup sleeve of the invention where the entire sleeve is made from an expandable material.

FIG. 19A is a perspective view of an alternative expandable sleeve.

FIG. 19B is a top view of the sleeve shown in FIG. 19A.

FIG. 19C is a top view of an alternative embodiment of the sleeve shown in FIG. 19A.

FIG. 19D is a partial view of an alternative expandable portion for a cup sleeve.

FIG. 19E is a perspective view of an alternative embodiment of a sleeve for absorbing condensate.

FIG. 20A is a top view of a partially assembled alternative expandable sleeve.

FIG. 20B is a top view of the expandable sleeve presented in FIG. 20A highlighting the assembly thereof

FIG. 20C is a front view of the sleeve of FIGS. 20A and 20B, showing a removable tear strip for expanding the expandable sleeve.

FIG. 21 is a flow diagram illustrating the process for manufacturing a paper-based sleeve such as the type shown in FIG. 2 or 3 that absorbs condensate.

FIG. 22 is a flow diagram illustrating the process for manufacturing a film-based sleeve that collects condensate.

FIG. 23 is a representation of an embodiment of the method of manufacturing sleeve blanks.

### DETAILED DESCRIPTION

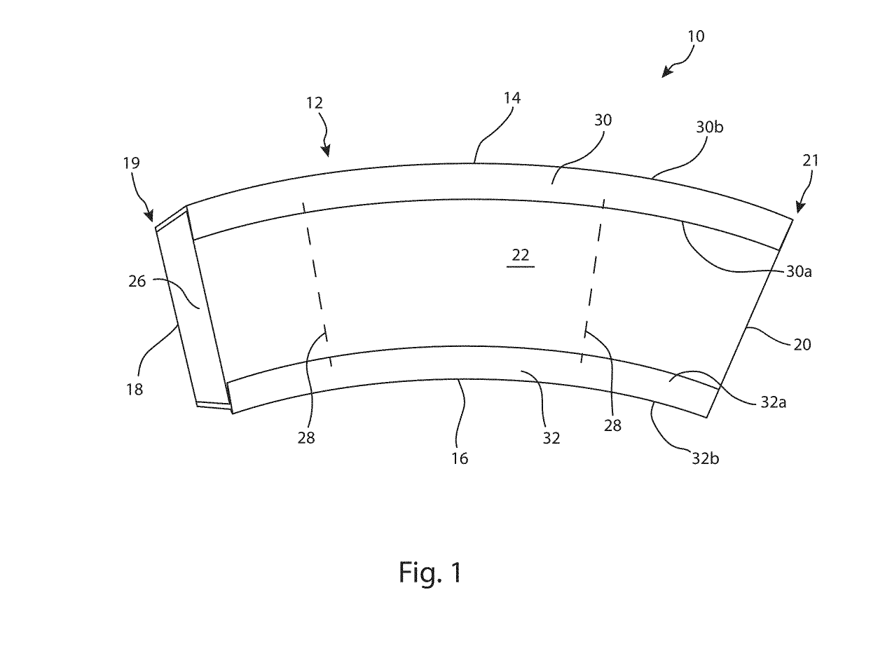

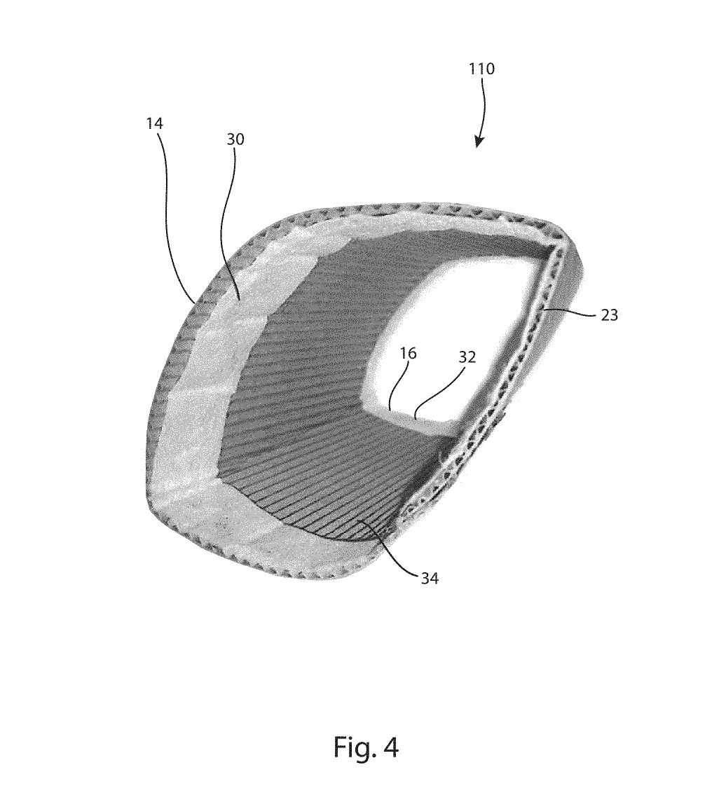

In one form of the invention shown in FIG. 1, a cup sleeve 10 may be formed from a blank 12 having a upper and lower arcuate edges 14, 16, and first and second side edges 18, 20. The edges 14, 16, 18, 20 are configured so as to form a frustoconical sleeve 10 when the inner surface 22 of a first end 19 of the blank 12 is bonded to an outer surface 23 (See FIG. 4) at the second end 21. The inner surface 22 of the blank may be a fluted paperboard material which includes a glue area 26 that extends along a height of the first end 19 and is configured to receive an adhesive, such as a hot melt adhesive or a cold set glue, and which is bonded to the outer surface 23 of the second end 21. The blank 12 includes perforations or score lines 28 that facilitate folding of the sleeve 10 such that the sleeve may be kept in a flat orientation for shipping and storage prior to use. In one form, the blank 10 is formed from single faced, E or F-fluted paperboard, i.e., an outer paper layer attached to a fluted inner layer. In addition, the blank 10 may include an expanded insulation material located between the inner and outer layers, such as described in U.S. Pat. Nos. 8,529,723 and 9,056,712, the disclosures of which are hereby incorporated by reference in their entirety.

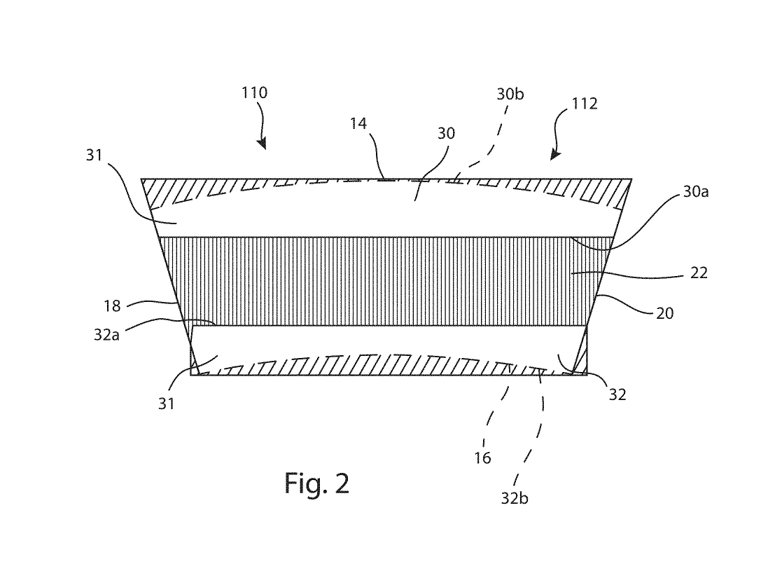

In one preferred form shown in FIG. 2, the sleeve 10 includes separate upper and lower absorbent strips or bands 30, 32 of a non-woven material that are attached to the inner surface 22 of the blank 10. The upper band 30 is positioned along the upper edge 14, and is spaced apart from the lower band 32, which is positioned along the lower edge 16. Both bands 30, 32 extend between the first and second ends 19, 21 of the blank, and preferably do not extend into the glue area 26 so as to not interfere with the bonding of the blank ends 19, 20 to themselves when forming the cup sleeve 10, and not introduce excess material along the seam, which can undesirably increase the thickness of the sleeve around the seam area such that the entire sleeve does not tightly hug the cup. The, excess parts of the bands 30 and 32, for example, can be removed by grinding or skiving during the sleeve forming process. The upper and lower bands 30, 32 form absorbent rings when the blank 12 is formed into a sleeve 10, 110 that preferably extend along the entire inner circumference of the sleeve, although small gaps may be present at the band ends due to manufacturing tolerances. The absorbent material used may be formed from a non-woven material that can be made of synthetic fibers, natural fibers, or a combination of synthetic and natural fibers. The non-woven material can also be made of multiple layers of these materials. Other materials other than non-woven materials may also be used. In a preferred embodiment, the absorbent bands are comprised of at least two layers of material, with a super absorbable polymer (SAP) disposed between each pair of layers as needed. The SAP may be in particle, powder, or fiber form (also named SAPF or SAF). For example, a super absorbent tape may comprise a SAP material disposed or embedded between first and second layers of polymer non-woven material. The non-woven material may itself be non-absorbent, and have SAP disposed between layers of the material to absorb condensation that travels through the non-woven material. Alternatively, a SAF can also be integrated or woven into a non-woven fabric, which allows for a single layer of material to be used to form the absorbent portion of the sleeve. In some forms the non-woven material is constructed of the same material as the cup so that the cup and sleeve are recyclable as a unit without the need to separate the sleeve from the cup. As the SAP absorbs water, the SAP material swells, which can also increase the degree of contact between the bands 30, 32 and the outer surface of a cup, further increasing the effectiveness of the bands 30, 32 for absorbing additional condensation. Other known absorbent materials could be used, e.g., air-laid cellulosic fiber nonwovens. However, SAPs are preferred because they have the advantage of being able to absorb substantially larger volumes of water compared to typical absorbent materials. For example, SAP is capable of holding up to 500 times its weight in water and expand 30 to 60 times its dry volume once the water is absorbed. Further, SAPs are not water soluble and turn into a gel when they absorb water, which substantially reduces the potential for wicking of absorbed water into the paperboard substrate of the sleeve 10. Advantageously, the potential for wicking of absorbed water into the paperboard sleeve is further reduced by using a non-absorbent nonwoven material with which the SAP is integrated, such as being disposed between multiple layers of non-absorbent non-woven material. In this form, the condensation may pass through the non-woven material and be absorbed solely by the SAP. In addition, SAP does not release water when squeezed or compressed by a user's hand. If a non-absorbent non-woven material is used with an SAP to form the absorbent material of the sleeve, the non-absorbent non-woven material will also not release any water when squeezed because all of the condensation will be stored in the SAP as a gel. The bands 30, 32 are preferably bonded to the inner surface 22 of the blank 12 using an adhesive, such as an emulsion adhesive. An air-laid cellulosic fiber nonwoven may also be used to form the nonwoven layers that are bonded to the paper layer, which advantageously allows the sleeve 10 to be recyclable as paper fiber. SAPs may be obtained from suppliers such as M² Polymer Technologies or BASF when in powder or particulate form and SAFs may be obtained from a supplier such as Technical Absorbents.

Testing by the applicants showed that separate upper and lower bands 30, 32 of SAP material were substantially as effective at absorbing all of the condensation generated on the surface of a cold cup compared to a sleeve having a single layer of SAP material covering the entire inner surface of the sleeve. Therefore, covering the entire inner sleeve surface is not necessary and using separate bands of SAP allows for a reduction of the cost of manufacture. In particular, the upper band 30 is fully capable of absorbing all of the condensation directly from the cup surface in and closely around the area where the band contacts the cup, as well as all of the condensation that drips downwardly from the cup surface that is above the upper band 30. The lower band 32 similarly absorbs all of the condensation from the cup surface in and closely around the area where the lower band 32 contacts the cup, as well as any condensation that drips down the cup surface from the area below the upper band 30. If any condensation were to pass by the upper band 30, the lower band 32 is fully capable of absorbing that condensate too, thereby acting as an additional layer of protection against the potential for condensate puddling.

Super absorbent polymers are relatively expensive, so generally, increasing the amount SAP material used within a sleeve of the invention will increase the cost of manufacture, so it is desirable to use the minimum amount of SAP that will still absorb all of the condensation generated on the wall of a plastic cup. The inventors have found through testing that between 5-12 grams of condensate, i.e. water, are generated on the outside surface of a cold beverage container containing an iced beverage over a period of time of 30-45 minutes in a typical summer environment where the average outside temperature is 85 degrees and the average relative humidity is 70%. Under those conditions, it has been found that in order to absorb all of the generated condensate in commercially available cup sizes, such as 6-32 ounces, the bands of absorbent material, such as an SAP-containing, absorbent nonwoven band, may have a range of widths, such as between ½ to 2-½ inches, with a preferred width of 1 to 1-½ inches. The bands of absorbent material may have a range of thicknesses too, such as 0.1 mm to 5 mm, with a thickness of 0.2 mm to 2 mm being preferred. The upper and lower bands 30, 32 may have an identical width, as shown in FIG. 1, or may they have different widths, such as shown in FIGS. 2, 3, and 4. The upper and lower bands 30, 32 may follow the exact arcuate configuration of the upper and lower edges 14, 16, such that they have a uniform but arcuately configured width, as shown in FIG. 1. Alternatively, as shown in FIG. 2, the bands may have a portion that has an arcuate configuration, 30b and 32b, along the respective top and bottom edges 14, 16, but also has a linear inner edge 30a, 32a that extends across the length of the blank 112. This configuration follows from the manufacturing process, which will be described in greater detail below. The above-described bands 30, 32 may also include undulating or other decorative patterns formed therein. The sleeve may also be provided with additional absorbent material bands spaced between the upper and lower bands 30, 32, such as one or more intermediate bands of absorbent material in uniform or non-uniform widths and thicknesses. Alternatively, only a single, lower band 32 of absorbent material could be positioned at the bottom of the sleeve 10 instead of two, spaced bands as described above. However, when employing only a single band, the band width and/or thickness may have to be increased in height and thickness in order to compensate for the lack of an upper band 30. In other forms of this embodiment of the invention, instead of the continuous dual, single or multiple bands of absorbent material, the absorbent material could be applied in a pattern, such as a matrix or irregular pattern of bands, dots, segments of bands, etc., so long as the volume of absorbent material is effective in absorbing the generated condensation.

As shown in FIG. 2, a blank 112 is shown similar to blank 12 of FIG. 1, except that the upper and lower bands 30, 32 are shown prior to being cut to size to exactly match the arcuate contour as the bands are rectangular when applied. Excess material that would be removed is shown in the shaded areas outside of the dotted lines indicating the outer boundary of the blank 112. In this form, the bands 30, 32 will have a variable width, meaning that outer edges 30b, 32b will have an arcuate configuration along the respective top and bottom blank edges 14, 16, but will have a linear inner edge 30a, 32a on that portion which extends across the length of the blank 12. In the disclosed form, the bands 30, 32 are formed from a nonwoven material containing a SAP in the preferred size range as described above.

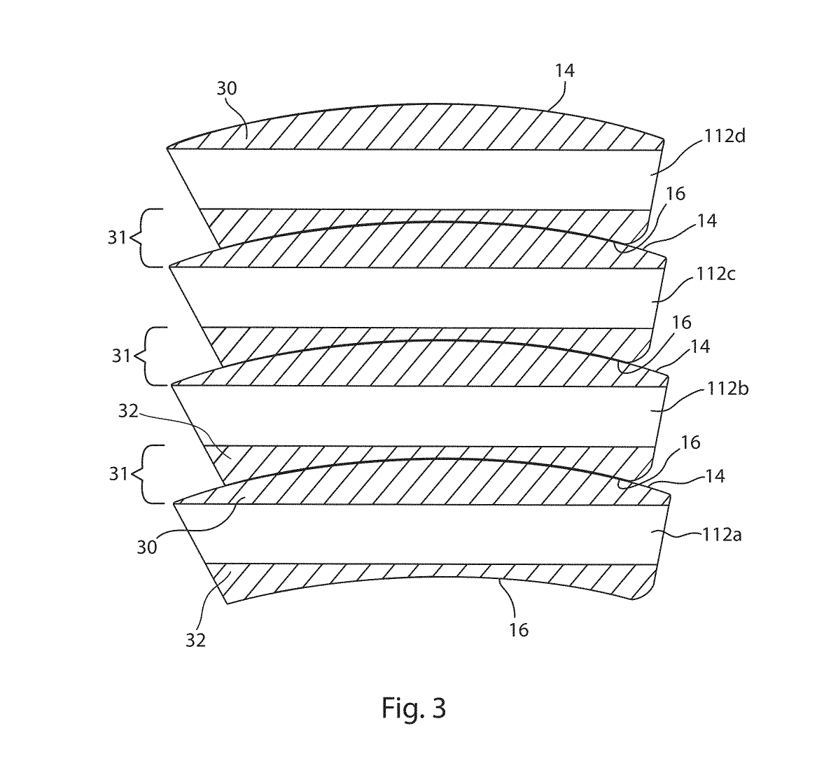

Alternatively, FIG. 3 shows an arrangement where multiple, consecutive blanks are first manufactured as a sheet of four separably connected blanks 112a-d, and then provided with the bands of absorbent material. Here, the upper edge 14 of a first blank 112a is abutting a lower edge 16 of an identical and attached blank 112b disposed above the blank 112a. A same strip of tape of absorbent material 31 forms both the upper band 30 of the blank 112a and the lower band 32 of the blank 112b above it. As shown, the strip of absorbent material 31 straddles and extends along the shared edges 14, 16 of the consecutive blanks 112a, 112b. The strips of absorbent material 31 would preferably be of a wider width or extent compared to the width of the strip of tape shown in the embodiment of FIG. 2 in order to accommodate the simultaneous formation of the both upper and lower bands 30, 32 on the consecutive blanks using a single strip 31. Accordingly, in the case of four blanks 112a-d being formed together, five separate strips of tape of absorbent material 31 could be used to form the upper and lower bands 30, 32 for the four blanks 112a-d, with the outer two strips respectively forming the upper band 30 of the upper most blank 112d, and the other outer strip forming the lower band 32 of the lower most blank 112a. The strips 31 would be perforated along with the edges 14, 16 of the blanks 112a-d to allow the blanks to be separated by a separating conveyor, such as shown and described in US Publication 2015/0314974, which is hereby incorporated by reference in its entirety. Although a sheet of four blanks is shown, any number of blanks with perforated strips may be cut simultaneously, and the process of creating the sleeves could be scaled accordingly.

As shown in FIG. 4, an assembled sleeve 110 is shown in a partially expanded orientation with the upper band 30 extending along a top edge 14 of the sleeve, and a lower band 32 extending along a bottom edge 16. In this embodiment, the bands 30, 32 are formed with a thin band of non-woven material containing a SAP. A portion 34 of the inner surface 22 of the sleeve 110 between the bands 30, 32 is exposed to and may come into contact with the outer surface of the cup particularly if the sleeve gripped tightly by a user. However, inner surface 22 can be treated with a water-resistant material so that any condensate formed on the surface of the cup wall in that area will not be absorbed into the paper substrate of the sleeve, but rather will drip downwardly and be fully absorbed by the lower band 32. Also visible is the outer layer 23 of the sleeve.

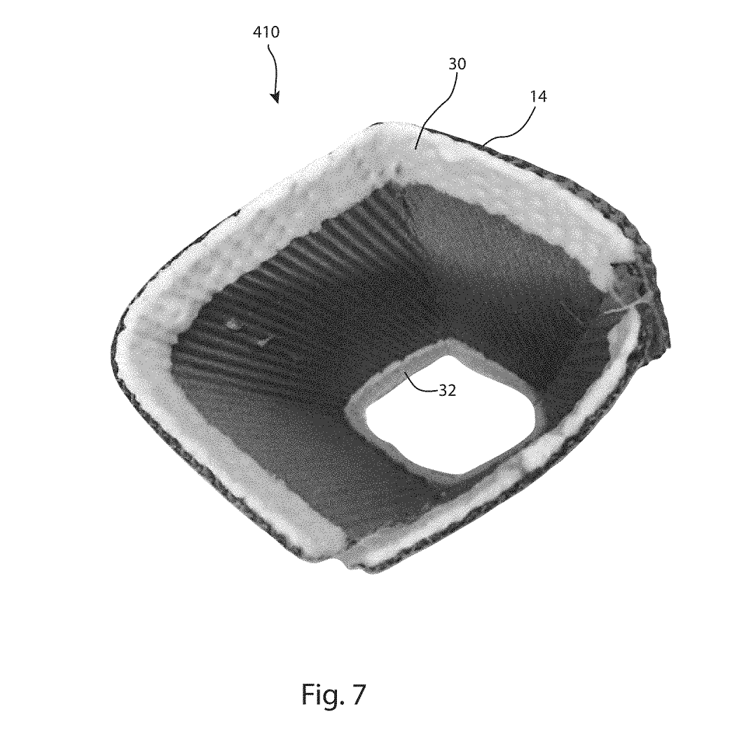

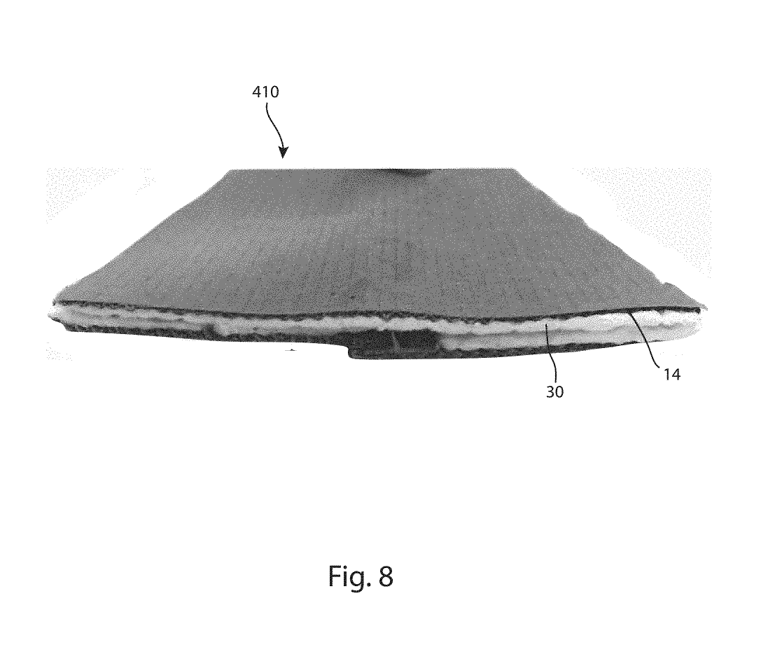

FIGS. 7 and 8 show an alternate embodiment of a sleeve 410 in the expanded and folded, compact configurations, respectively, using an absorbent SAP material provided in upper and lower bands 30, 32, similar to the embodiment of FIG. 1.

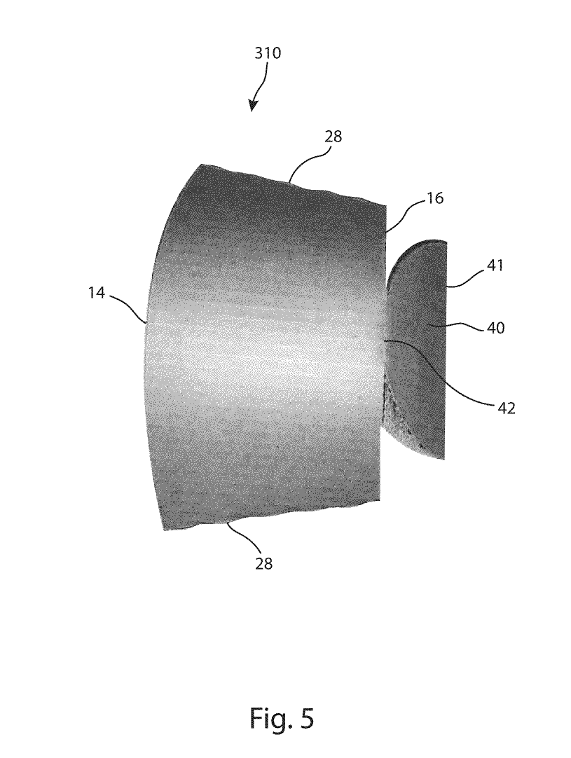

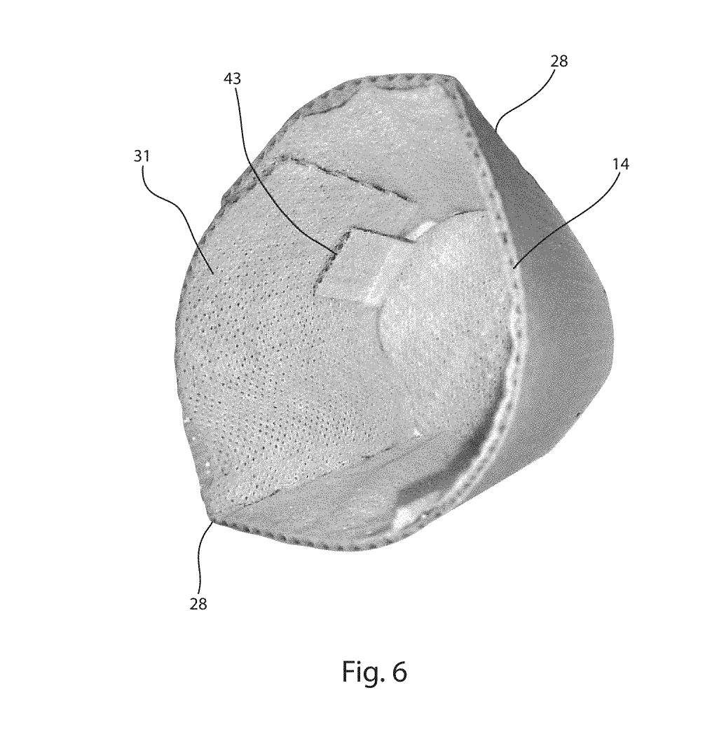

FIGS. 5 and 6 show an alternate embodiment of an assembled sleeve 310 having an integrated base 40. The base 40 has a circular configuration when the sleeve is positioned on a cup and is integrally connected along a connecting portion 42 thereof to the lower edge 16 of the blank. Opposite from the connecting portion is a tab 43 for being attached to an inner surface 22 of the blank, or the layer of absorbent material 31 that is attached to the inner surface 22. The base 40 is configured to fold along a fold line 41 so that the sleeve 310 may be stored in a compact or flat configuration with the sleeve being folded between score lines 28. In the disclosed embodiment, a dual or multi-layered nonwoven material 31 which includes a SAP disposed or embedded therein, is adhesively attached to the entire inner surface 22 of the blank and the inner surface of the base 40. The base 40 acts as an integrated coaster and provides additional protection against condensate potentially pooling at the bottom of the beverage container and dripping from the base of the cup. The sleeve 310 could also be provided with different configurations for the SAP or other absorbent materials, such as providing upper and lower bands that contain a SAP material instead of a single layer of absorbent material covering the entire interior surface of the sleeve.

In an additional embodiment of the present invention the blank 12 may be fixed to a container, such as a cup before being assembled into a cup sleeve. In this approach the cup would be provided with the sleeve attached thereto. In addition, expandable insulating material may be applied to the blank. For example, at least one of an inner surface or the outer surface of a side wall of a blank may be at least partially coated by a layer of a thermally expandable insulating material. The insulating material may be adapted to be expanded in a variety of ways to provide thermal insulation. The expandable material may be used to aid with insulating capabilities of the blank, and to add rigidity to the container or the die cut blank, such as to reduce a thickness of the material components of the blank. For example, the combination of an expanded insulation material provided between the fluted inner layer of the blank and the outer paperboard layer and the spacing of the outer surface 23 of the blank 12 from the cup outer surface also increases insulative properties of the sleeve 10, which reduces the amount of condensation generated on the cup, which increases user comfort and keeps the beverage cooler longer and reduces the rate of ice melt in the beverage.

The sleeve blank 12 may have various heights, depending on the size of the cup with which the sleeve will be used or it may have a single height that will be applicable to all cup sizes. Applicants found that for cups ranging in size from 16 to 32 ounces, that a sleeve height of between about 2-½ to about 5 inches was preferable. In particular, it is desirable to have the sleeve extend high enough on the cup so that a user may grip the cup comfortably about the sleeve without touching the cup itself. Further, it is desirable for purposes of absorbing all or substantially all of the condensation that the lowermost part of the sleeve be in a position that is at or near the bottom of the cup when inserted onto the cup and that the remainder of the sleeve be sized to extend to at least a midsection. If a sleeve is provided such that there is an exposed area of the cup below the sleeve, then that section will generate a small amount of condensation that will not be absorbed unless an optional bottom coaster is provided as shown in FIGS. 5 and 6.

Cups, especially those of larger size, may have an outer wall that does not have a constant outside diameter from its top to bottom or the cups have a lower portion with a smaller outside diameter than the diameter of the top portion of the cup. These types of cups are usually designed with the intention of ensuring that the cup will fit within an automobile cup holder. In such a case, the sleeve 10 may be made to fit the upper portion of the cup, or the sleeve 310 with an integrated base may be used for such a cup. If the difference in diameter between the top portion and lower portion of the cup is not too large, the sleeve may be provided with a thicker lower band 32 of absorbent material such that the lower band 32 will be in contact with the cup surface near the base of the cup

Each of the embodiments described to this point contemplate a sleeve constructed form an opaque material. In another preferred embodiment of the invention, a partially or fully transparent sleeve is provided that can collect and retain condensation and insulate the cup to prevent sweating, pooling and dripping. Because typical beverage sleeves are made of paperboard, they are opaque and a user cannot see through them. This is not an issue for typical single-use coffee and tea cups that are generally paper-based and similarly opaque. However, cups intended for cold drinks may be transparent, and it is desirable for users to be able to view the beverage contained in the cup. Known paperboard cup sleeve obscures at least a portion of the contents of the cup, and in the case of taller cup sleeves, such as a cold cup sleeve disclosed herein that extends from the base of the cup, much of the cup could be covered by the sleeve. Accordingly, a sleeve that is at least partially transparent is desirable. However, as most known absorbent materials are opaque, they do not lend themselves to being used in applications where the desire is to provide a partially or fully transparent sleeve.

According to another embodiment of the present invention, a sleeve is provided with either a transparent or opaque outer substrate that is attached to a transparent inner layer. A transparent outer layer may comprise a plastic-based layer of PET, such as MYLAR® polyester film or any other suitable plastic such as a PLA or PP. The inner layer may be provided with absorbent or non-absorbent features for insulating the user's hand from the cup and may also be provided with features for capturing the condensate to keep it from traveling to the base of the cup during the time of the cold beverage consumption. In one aspect, the inner layer may comprise a PET, PP or PLA based absorbent nonwoven material that matches the type of plastic of the outer layer and can include an embedded or trapped superabsorbent polymer or superabsorbent fiber. When the outer layer and inner layer are made of a like plastic such as a PET material, the entire sleeve can be recyclable, such as under recycling code SPI #1 for PET. If the outer and inner layers are made of a compostable material such as a PLA material, then the entire sleeve can be compostable.

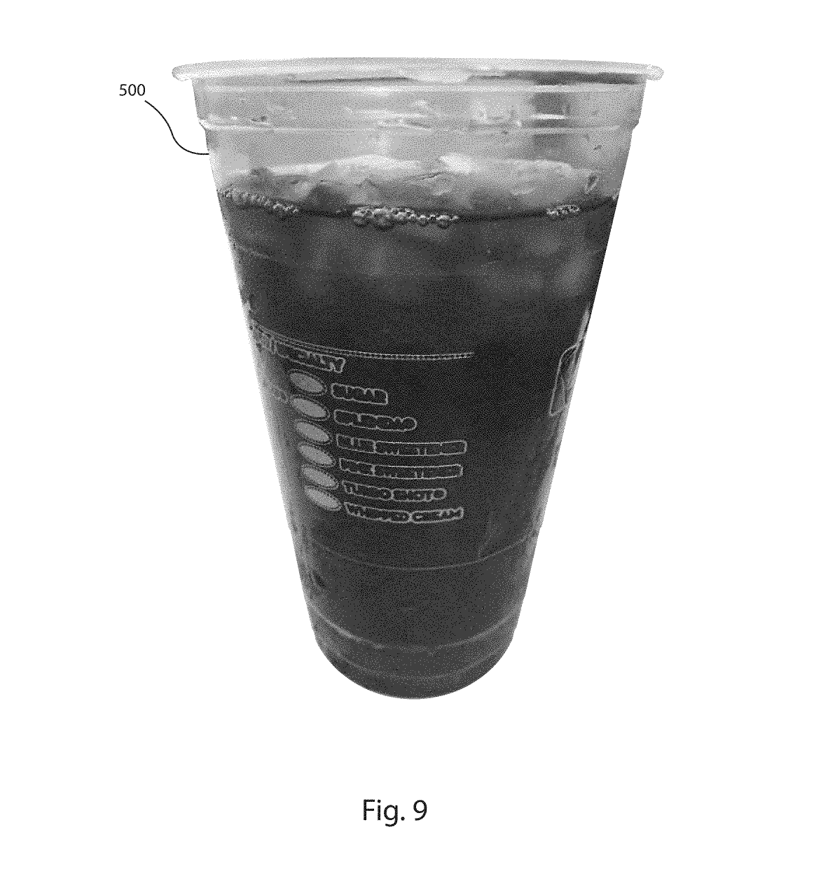

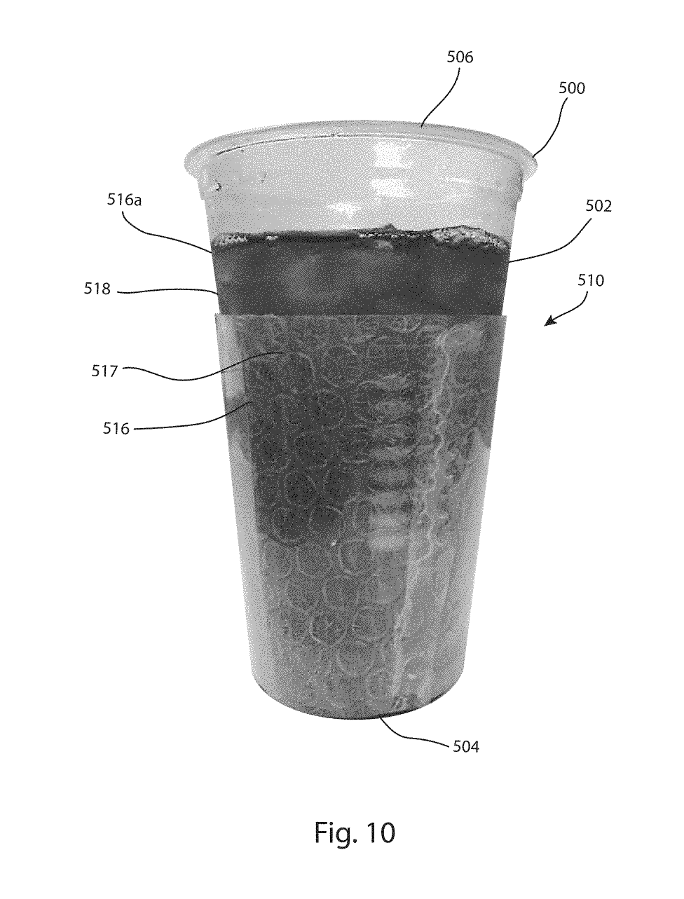

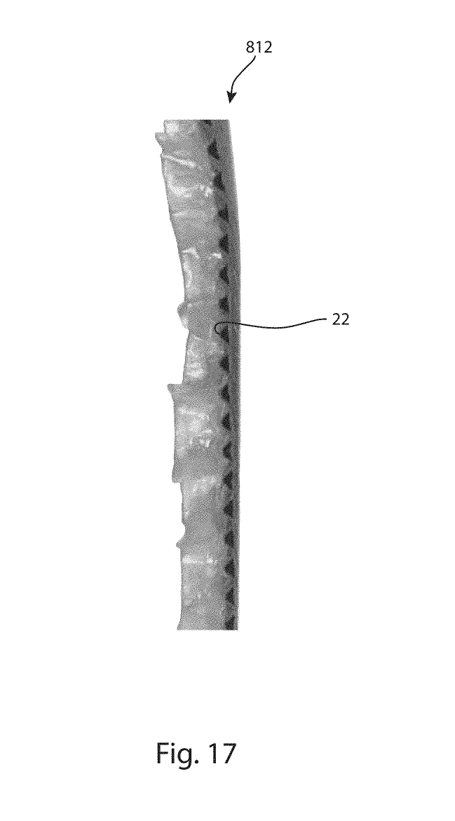

As shown in FIGS. 10-17, various sleeves are shown that include an inner layer or substrate having surface entrapment features such as protrusions, textures, voids, pockets, or cavities in various forms, patterns, shapes and depths that are effective for trapping or capturing water condensation therein when placed in contact with or closely adjacent to an outer surface of the cup 500. Unlike an absorbent material, these interior surface features are not designed to absorb the condensate but rather are designed to trap or capture and then retain the condensate that would otherwise migrate to the bottom of the cup 500, shown in FIGS. 9-11. However, it is possible that that the entrapment features allow some condensation to pass by, and additionally, some of the condensate captured may not be permanently retained by the entrapment features. The surface features may rely on a physical obstruction to promote water trapping through surface adhesion between the condensation droplets and the surface features, through circuitous or tortuous dispersion of the water droplets throughout the surface features, or a combination of these mechanisms. The surface features may form cavities or voids to capture the condensation therein. An absorbent material may also be used, instead of, or in addition to the non-absorbent surface features such as cellulosic fibers of the wet-laid or air-laid type, or a nonwoven material that contains a superabsorbent polymer or superabsorbent fiber. The construction of the surface features also provides excellent thermal insulation by effectively creating air gaps between the outside wall of the cup and the outer layer of the sleeve. It is well known that air is an excellent insulator and the insulation that is provided by the sleeve of the present invention assists in keeping the iced beverage colder for longer periods of time, as well as protecting the hand of a user from the cold. To a lesser effect, the insulation slows the growth of condensation droplets on the outer cup surface in the area which is protected by the sleeve.

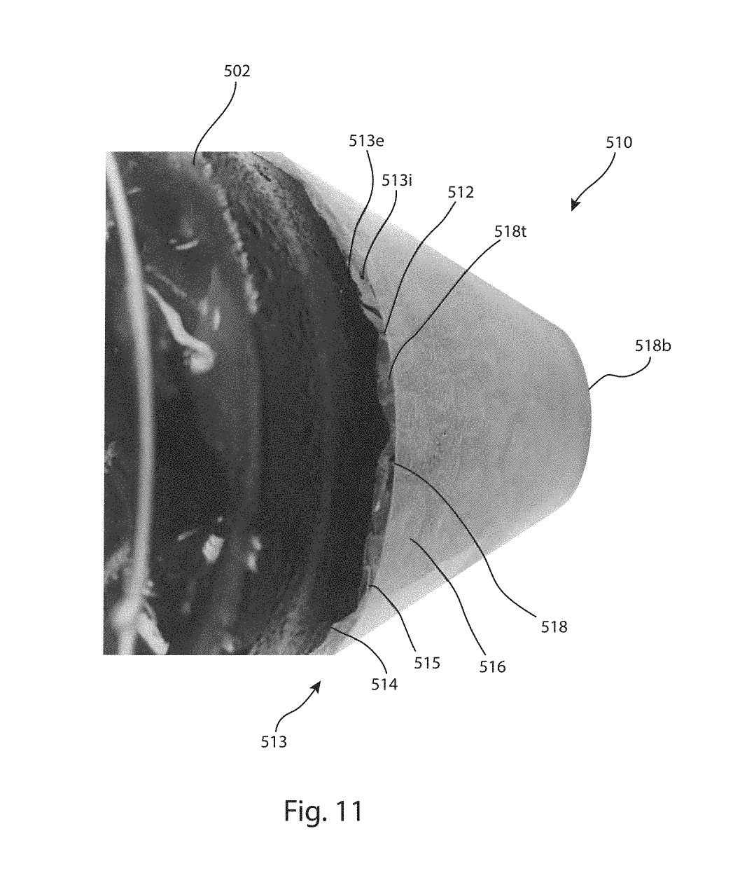

For example, FIGS. 10 and 11 illustrate a transparent sleeve 510 having a transparent outer substrate or layer 512 made from a polymer film that is laminated to an inner substrate or layer 514. In this form, the inner layer 514 is comprised of a matrix of air-filled hemispheres or cylinders 516 that form an entrapment wrap 513, which is typically formed from a polyethylene (LDPE) film. Preferably, the outer layer 512 is made from a semi-rigid, i.e., capable of retaining a shape, yet still flexible material, such as a polyester film like PET. Other materials may be used to form the inner substrate, such as polypropylene (PP), polyethylene (PE), polyamide (PA or nylon), polyvinyl chloride (PVC), polystyrene (PS), polylactic acid (PLA) and the like. Depending upon the height of sleeve 510, the thickness of outer layer 512 must be sufficient to give the sleeve sufficient rigidity to allow the sleeve 510 to be pushed upwardly around the outside wall of the cup 500, otherwise the sleeve will have a tendency to collapse as it is pushed onto the cup. Therefore, it is preferred to use thicknesses of various gauges such as from 1 to 10 mil, with taller sleeves being constructed of a heavier gauge. The figures show sleeve 510 positioned about a transparent cup 500 such that the inner layer 514 engages directly with the outer surface of the cup 502. The sleeve 510 extends from the cup base 504 toward the cup rim 506 such that the sleeve 510 covers at least a majority of the outer cup surface 502. Preferably, the sleeve covers a sufficient area of the outer surface of the cup such that the user may hold the cup comfortably without touching a substantial portion of the cup wall. By providing a sleeve as such, the user's hand will not get wet and will be protected or insulated from the cold contents. When the outside laminate of the film and an inside laminate comprising an entrapment material layer is made into an assembled sleeve, the entrapment material layer in the area of the seam of the outer layer can either be melted and bonded to the outer film at the seam under heat and pressure, be sized not to interfere with the joining of the seam, or be stripped off or away from the seam area after the inner layer is applied to the outer layer so that the seam of the outer layer is bonded, film to film. When the plastic outer layer 512 and the inner layer 514 are made of the same type of plastic, the sleeve 510 is recyclable and if they are made of the same compostable plastic, the sleeve is compostable.

In the form shown in FIGS. 10-12, the entrapment wrap 513 itself is formed from two layers of film, an inner layer 513i and an outer layer 513e with the air-filled pockets 516 formed between layers having a cylindrical or hemispherical shape. Thus, the pockets 516 are projecting outwardly from the outer layer 513e and are in contact with the outer surface 502 of cup 500. Accordingly, condensation may be trapped by the sleeve 510 in a number of ways. First the condensate may be trapped within partial, deflated pockets 516a that are usually cut open and become deflated at the uppermost edge 518t or the lowermost edge 518b of the sleeve 510. Second the condensate may be trapped between the minute voids or cavities 517 between the pockets 516 through the non-wetting and clinging phenomenon of surface tension acting between the condensate droplets and the plastic film from which the pockets are formed. Only when the volumetric weight of a condensate droplet overcomes the surface tension, will a droplet move downward to the next row in the matrix. Because of the arrangement of the rows of pockets and the tight spacing between individual pockets, a condensate droplet will not descend directly to the bottom of the sleeve but rather must undergo a rather circuitous and tortuous route downward from one row of air-filled pockets to another with the surface tension forces acting on the condensate droplets each and every row. During the time most users take to consume the cold beverage, the condensate droplets at the top of the sleeve will not migrate to the bottom of the sleeve structure. Third, the condensate may be trapped between the outer layer 513e of the entrapment wrap 513 and the outside surface 502 of cup 500. Because the wrap 513 is not rigid, the inner layer 514 may present areas of the sleeve that are in very close contact with outer surface of the sleeve and these areas create zones within the sleeve that are effective to capture the water droplets between the cup and the inner layer 514.

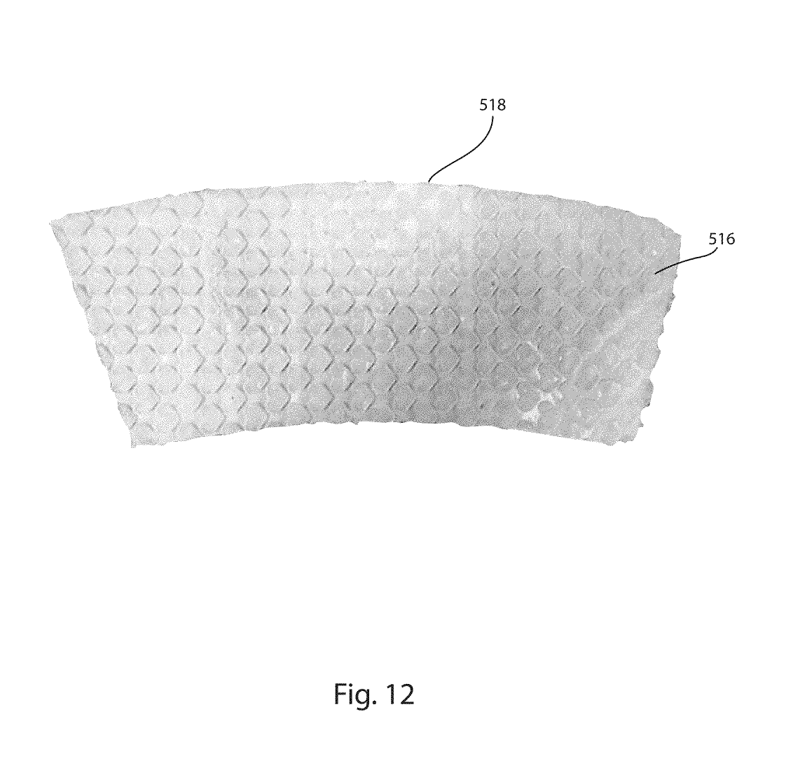

FIG. 12 illustrates a sleeve 710 made with another type of entrapment wrap material having heart-shaped entrapment features 716. This particular configuration is merely an example of the wide variety of entrapment features the sleeve could take on in order to create areas on the sleeve that entrap condensation. For example, the sleeve can be formed with an outer film layer with air-filled compartments attached thereto having various shapes, such as spaced rows of lines that each have a sinusoidal configuration, rows of identical geometric shapes that contact each other, or any other rows of designs, lines, and patterns effective to trap the condensate between the rows of air-inflated compartments.

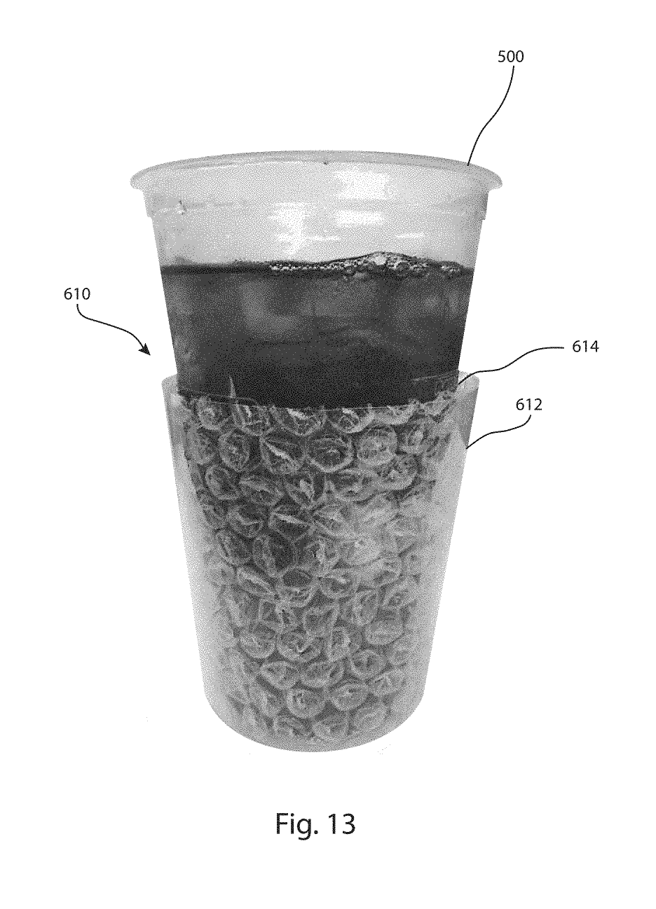

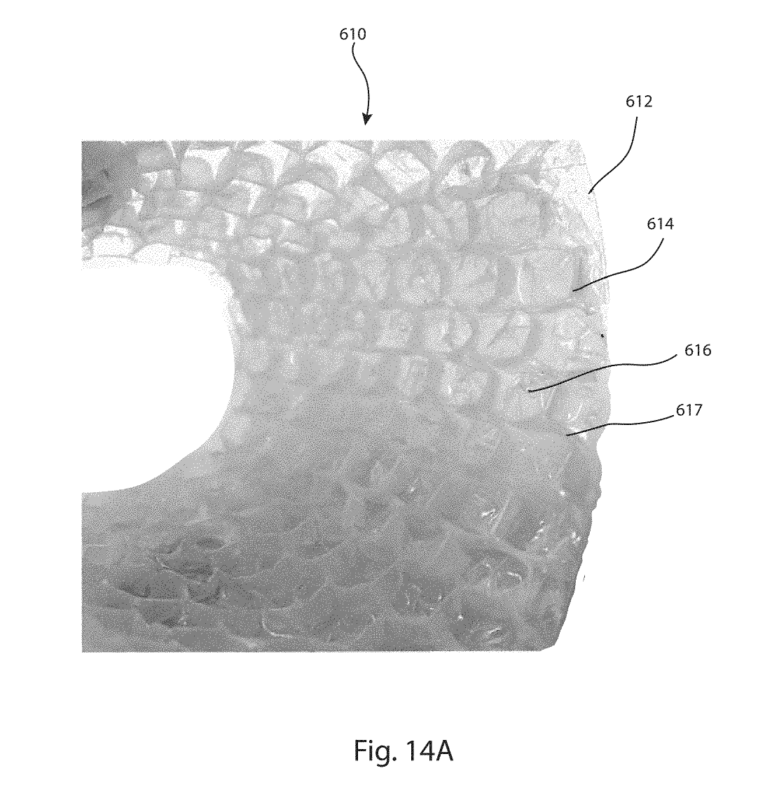

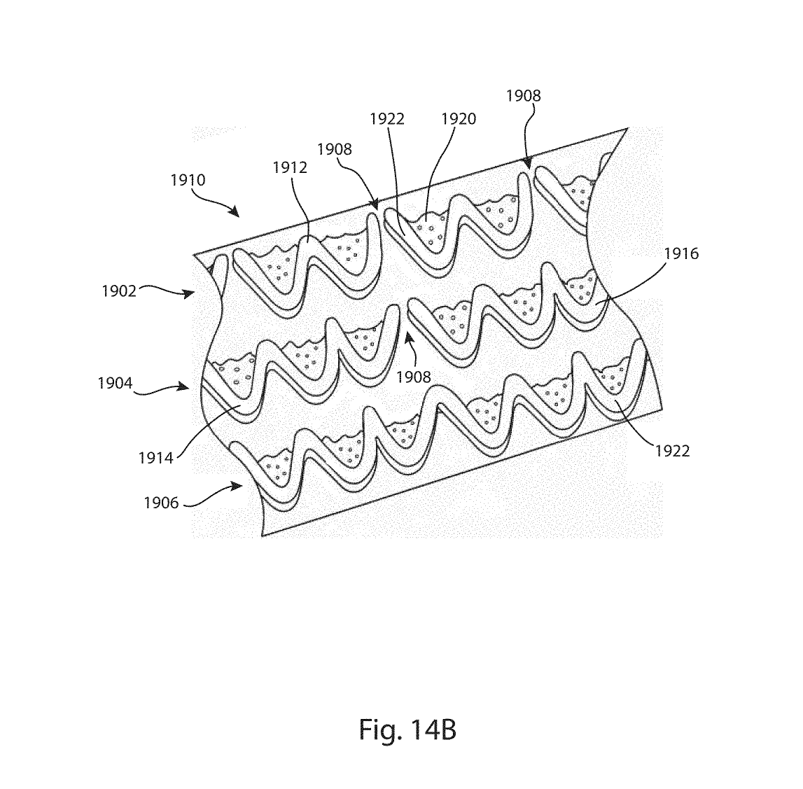

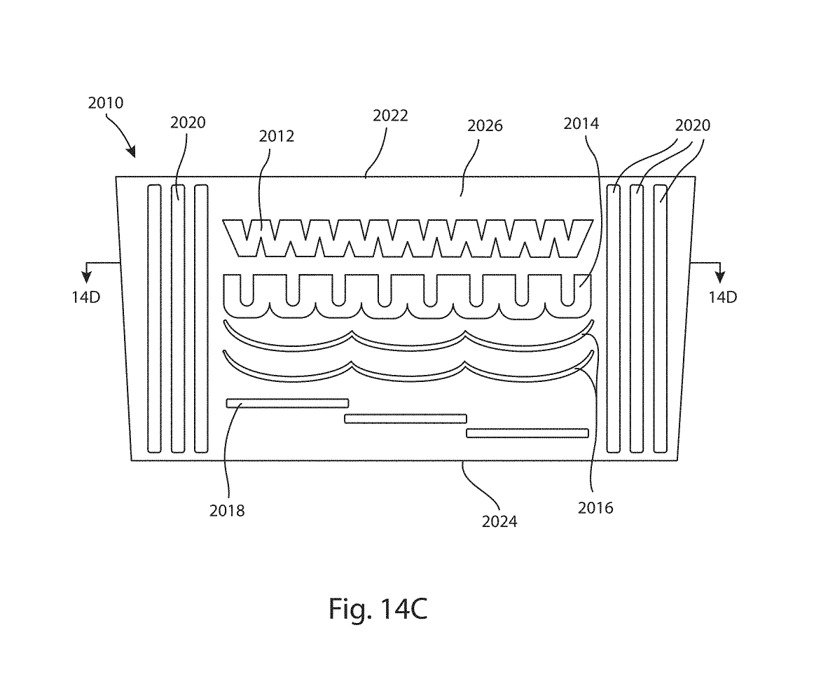

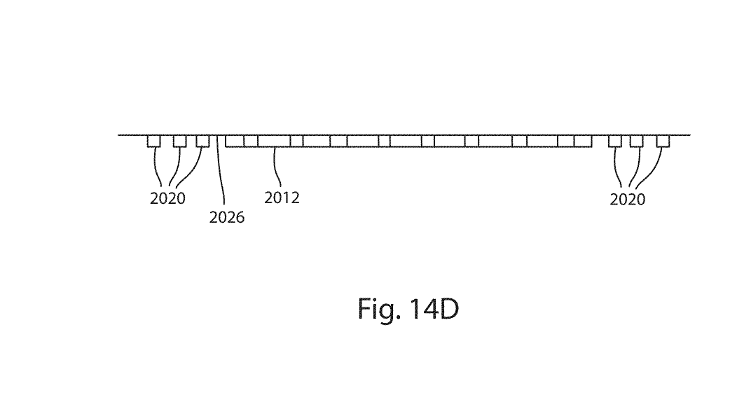

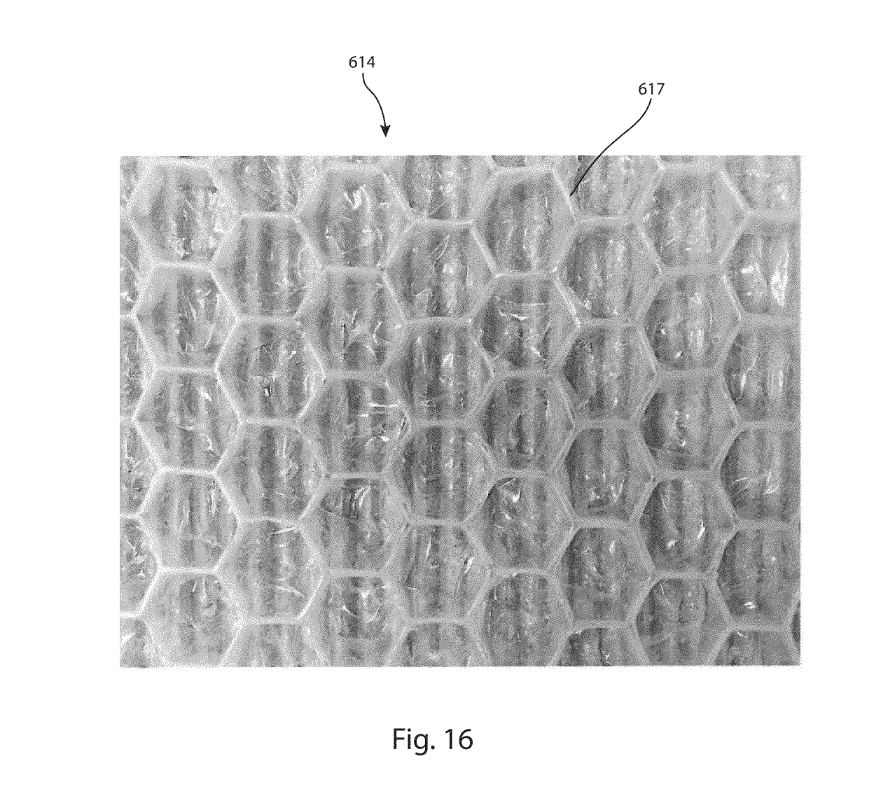

In another form shown in FIGS. 13 and 14A, a transparent sleeve 610 which is structurally similar to the form shown in FIGS. 10 and 11 is formed with a transparent outer film layer 512 and an inner layer 514 where the inner layer 514 is comprised of a single sheet of transparent film formed, such as through thermoforming, into hexagonally-shaped cavities that are arranged into a honeycomb lattice structure. The walls of each of the hexagonally-shaped cavities can also be formed as air-filled compartments. One side of the lattice structure is open and one side is closed. This structure is best seen in FIG. 16, where the honeycomb lattice is identified as element 617, attached to a paperboard outer layer 614 rather than to the transparent layer provided and shown in FIGS. 13 and 14A. Similar to the embodiments of FIGS. 10 and 11, the honeycomb inner layer is bonded to the inner surface of the semi-rigid outer layer 512. In operation, the open hexagonal cavities 617 contact the outer surface 502 of the cup 500 when the sleeve is snugly contacting the wall of the cup, whereby condensation that forms will cling to the walls surrounding the cavities or be immediately captured and pool within the individual cavities 617, thereby capturing substantially all of the condensation that forms. Instead of a honeycomb lattice, the inner layer 514 may be formed into any variety of shapes or patterns effective to capture condensation, including, but not limited to circles, polygons, letters, lines, etc. In an alternative form, the outer layer 512 can be omitted, particularly when the inner layer 514 is sufficiently rigid to be slipped around the outside of a cup without difficulty.

FIG. 14B illustrates a portion of a sleeve 1910 having a top row 1902 of separate entrapment features in the form of “w”-shaped air-filled compartments 1912, an intermediate row of repeating “w” shaped segments 1914, 1916 with a gap 1908 located between the two segments, and a bottom row 1906 of a continuous repeating “w” shaped segment. The side of the sleeve 1910 shown in FIG. 14B is the inner, cup facing side, such that each of the entrapment features would be in contact with the cup when the sleeve is positioned about the cup outer surface. As shown, each “w” shape in each row has condensation 1920 pooled in upward 1920 facing valleys 1922 formed by each “w.” The condensate would be captured between the cup (not shown) and the outer sleeve layer 1924. By providing gaps 1908 between the letters 912 or segments 1914, 1916, some condensate is allowed to descend to the next row of entrapment features. Accordingly, any condensation overflow from the w-shaped features 1912 of the top row 1902 may travel through the gaps 1908 to the next row 1904, 1906, acting as a relief mechanism for the top or subsequent rows 1902, 1904. The entrapment features may be provided with or without gaps 1908 as desired. Preferably, the bottom most row of entrapment features 1906 is provided without gaps to keep condensate from leaking out of the bottom of the sleeve 1910. Thus, if the pattern is discontinuous, each row of the chosen pattern will hold the water that emanates from the cup in the space above the respective entrapment feature. In addition, shapes like alphanumeric characters including but not limited to the letters H, J, K, M, N, U, V, W, X, and Y, when made in rows, will present portions of the letter that will readily collect condensation, i.e., the portions that are open at the top and closed at the bottom. However, other shapes and patterns could be used, as long as the condensation is captured by the entrapment features. One advantage of using such an inner layer to form entrapment features would be to allow customers to customize their own sleeves to include entrapment features that represent brands, logos, trademarks, slogans, or other information, while maintaining the functional aspect of collecting condensation from the cup. Instead of being air-filled, the entrapment features shown in the above embodiments could be formed by thermoforming a single layer of film similar to the inner layer of the sleeve 610 in FIGS. 13 and 14A in the desired pattern. The outside layer 712 of a sleeve formed with this type of inner layer would be made from a semi-rigid and transparent material that is preferably of the same type of material as the inner layer so that the entire sleeve is compostable or at least recyclable. Further, a semi-rigid and transparent outer sleeve is printable like a paper sleeve. That feature has been found to be extremely cost efficient because a customer's logo or design can be printed on the outer layer of the sleeve instead of printing the same of the outside surface of the cups. Changing the print location of the company logos and designs to the sleeve allows the restaurant or fast food chain to purchase much cheaper, print-fee cups.

In another form shown in FIGS. 14C, D, instead of being formed from an air-filled film, the entrapment features may be formed by embossing or debossing the sleeve 2010. The entrapment features similarly may take a variety of shapes that are effective to capture or collect condensation, such as, for example, a repeating “w” or “u” shaped feature 2012, 2014 or a wave-like feature 2016 that extends horizontally along the sleeve 2010. The entrapment features may also take the form of straight line segments 2018 that are effective to collect or redirect condensation to other entrapment features. The sleeve may also have embossed expansion features in the form of a plurality of vertically extending segments 2020 that permit elongation of the sleeve 2010 when an expansion force is applied thereto, such as by sliding the sleeve about a cup to a position on the cup having an external circumference that is larger than the circumference of the sleeve prior to expansion. In particular, the embossed vertical segments 2020 will be caused to flatten into a planar or flat state, thereby lengthening the sleeve by an amount corresponding to the depth of the embossed vertical segments 2020, i.e. the portion of the embossed segments that extend transversely from the flat face of the sleeve 2010. Although not shown, the vertically extending embossed segments preferably extend from the top edge 2022 of the sleeve to the bottom edge 2024 to allow the sleeve 2010 to be expanded. The greater the number of vertical segments 2020, the easier the sleeve will extend. The sleeve 2010 may be formed from a flat substrate made from a paper or plastic material. When made from a paper material, the inner surface 2026 of the paper may be coated with a water-resistant material to inhibit absorption of condensation.

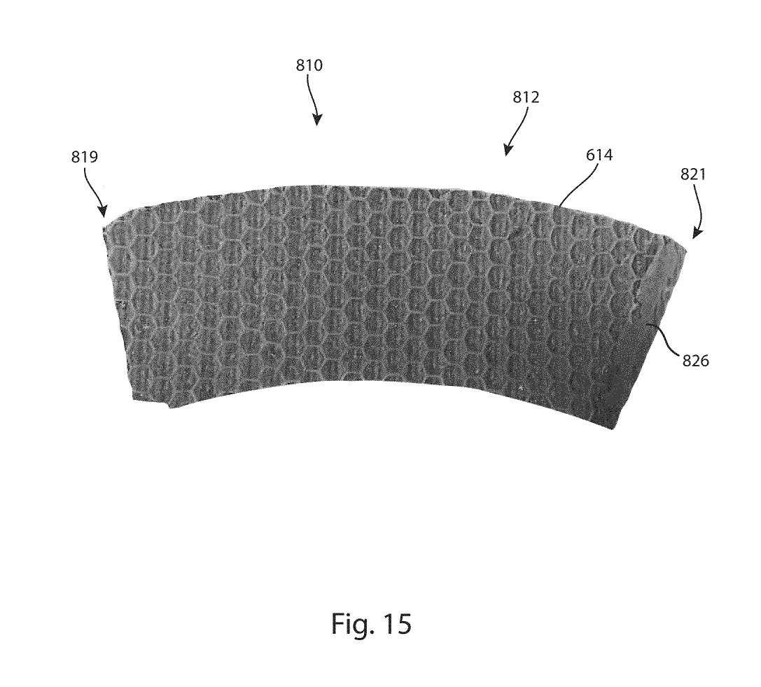

FIGS. 15-17 illustrate another alternate form where the outer layer 812 of a sleeve 810 is formed as a single face e-flute corrugated paper material, although an outer layer of paperboard material without a corrugated inner layer may also be used. The inner layer 814 is provided with the hexagonal or honeycomb lattice that is identical to the inner layer material used in the embodiment of FIGS. 13 and 14A. In particular, the closed side of the lattice structure is adhered to the fluted inner surface 22 of the blank 812. While this embodiment is not transparent, the honeycomb cells operate in a similar manner to capture the condensation droplets, as previously described. In addition, because the inner layer is not absorbent, it keeps the condensation from wicking into the inner surface of blank 22.

Preferably the glue area 826 along one end 821 of the blank 812 best shown in FIG. 15, is free from the inner layer material 614, so that the ends 819, 821 may be bonded together to form the sleeve 810, in the same manner as discussed with respect to the embodiment of FIG. 1. This can be accomplished by abrading a portion of the inner layer 614 off at the glue area 826 after the inner layer 614 is adhered to the blank 812 or this can be accomplished by intentionally making the inner layer with a shorter extent than the outer layer so that the glue area does not require abrading, or it can be accomplished by abrading a portion off at each end 819, 821. Alternatively, the inner layer material 614 can be melted under high temperature and pressure, and hence can be bonded onto the ends of the sleeve without the need for glue or abrading of the inner layer at the seam area before bonding.

In another aspect of the invention, it is desirable to provide a single sleeve which will closely contact the outside surface of a number of different size cups. Most plastic beverage cups will have an outside wall that decreases in diameter from top to bottom or they may have an outside wall that is comprised of two distinct diameters or the cup may even have an outside wall that is of a constant diameter from top to bottom. In addition, it is common that cup outside wall diameters are not consistent between cup sizes. For example, a 12 ounce cup will have an outside diameter that is different than a 24 ounce cup and the 24 ounce cup will have an outside diameter that is different form a 32 ounce cup and so on. To satisfy the desire of a single sleeve fitting any cup diameter, the inventors of the present invention have developed several features to adapt a cup sleeve so that they are extendable or stretchable from the smallest diameter cup to the largest diameter cup of a target cup set that is typically served by fast food restaurants or coffee shops. In this way, these establishments would need to stock only a single sleeve rather than purchase and store several sizes of sleeves, thus saving valuable storage space and operating costs. Furthermore, it has been measured that the outside diameters of the various common cup sizes have about a 7-8% difference between outside wall diameters between them. This difference amounts to a few millimeters in circumference that a sleeve must extend in order to accommodate a larger diameter cup wall, Therefore, the concept of an extendable sleeve can be satisfied by providing either a part of or an entire sleeve made from a material that can be either extended or stretched, or it can comprise additional sleeve material that can be mechanically expanded to accommodate cups with various diameters. Additionally, extendable sleeves may also be provided with a variety of absorbent nonwoven materials that are capable of absorbing substantially all of or a sufficient amount of the condensate generated to address the problems described herein above.

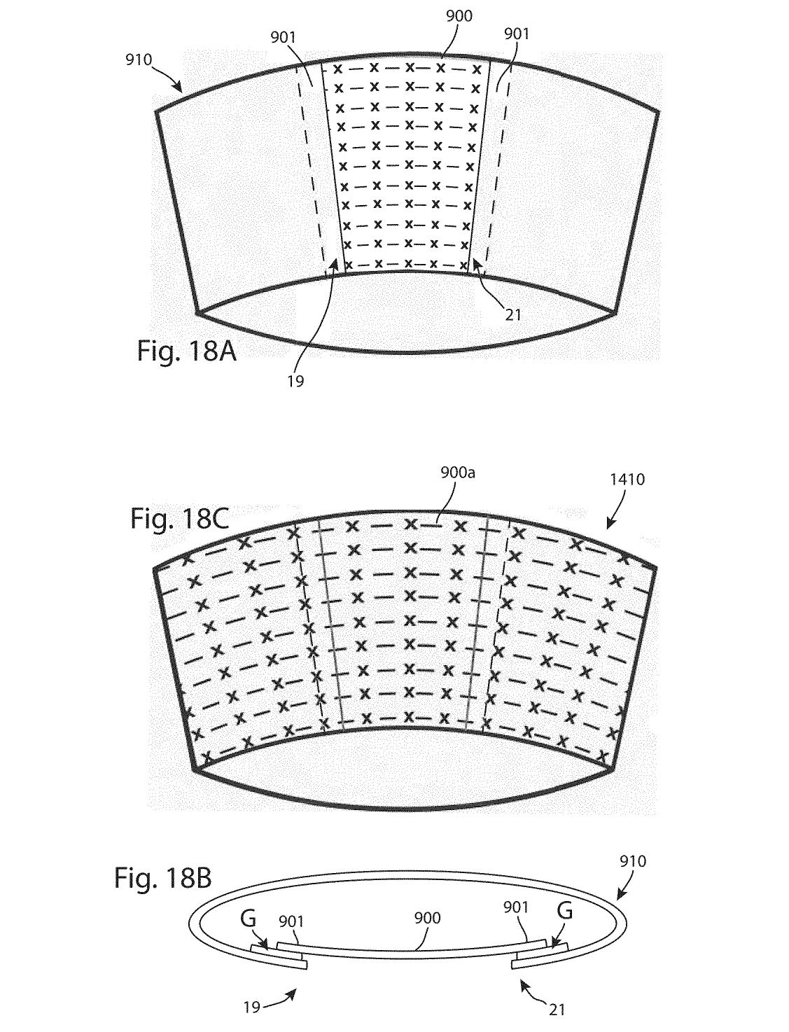

Turning to FIG. 18A, a first embodiment of an extendable sleeve 910 of the invention is shown, whereby one of the sleeves presented earlier herein is adapted with an extendable section which is expandable or is extensible so as to fit a variety of cold cup diameter sizes. In an unexpanded configuration, the sleeve is sized to fit the outside diameter of a typical cup, such as a 12 ounce cup although the concept is applicable to cups having different diameters. This particular extendable sleeve is primarily applicable to paper-based sleeves. In this version, that part of the sleeve near the seam has either been cut and removed or the sleeve has been manufactured to leave the sleeve ends 19, 21 un-joined so that an additional portion of material can be added without the need to cut and remove a section. Extendable section 900 is slightly longer than the gap between the sleeve ends 901 so that the ends 901 thereof can be attached to the inside surface of the sleeve, which is the side that will contact the outside wall of the cup. The lateral ends 901 of the extendable section 900 are shown in dashed line form in order to clarify the area on the sleeve where they will be attached, on the lateral ends of the sleeve 19, 21. Any means for permanently attaching ends 901 to the sleeve may be used such as but not limited to a cold or hot melt glue “G” or by thermal bonding techniques (See FIG. 18B). The type of attachment will be dependent upon the type of extendable material that is used, namely whether it is an extensible material or an expandable material. For example, extendable section 900 may comprise an extensible material such as a micro-crepe or extensible paper which is available through the Mondi Company. The extensible material incorporates microscopic folds that are not visible to the naked eye but provide the material the capacity to extend 5-25% beyond its resting length when placed in tension. When the sleeve 910 is pushed upwardly around a cup having an outside diameter which is larger than a predetermined size, such as that of a 12 ounce cup, the extendable section 900 will extend when the sleeve is placed around the outer wall of the cup and pushed upwardly by hand with an appropriate force from its resting state size to that of the diameter of the cup around which the sleeve is positioned. The microscopic folds within material 900 will be placed under tension and extend only to the extent corresponding to the tension of the extendable section 900 force applied. Thus, when used with larger diameter cups, more tension will be applied when pushing the sleeve upwards, causing more of the microscopic folds to extend. Alternatively, extendable section 900 may comprise a heavy crepe paper which contains visible folds of unexpanded material formed therein but extends to a lesser degree than a micro-crepe paper. In some instances, a greater lateral extent of the extendable section 900 may be required with a heavy crepe paper versus a micro-crepe paper in order to achieve the same amount of lateral extension.

The extendable section 900 may also comprise any kind of extendable material such as but not limited to an elastomeric material or a stretchable natural or synthetic non-woven or woven material. The expandable elastomeric or natural or synthetic non-woven or woven material may be permanently attached directly to the inside surface of the sleeve by various thermal bonding techniques or by adhesive attachment at locations G. More than one area on the sleeve may be provided with an extendable section 900.

FIG. 18C shows another embodiment of an extendable sleeve 1410. Here, the entire sleeve substrate is made from a stretchable material 900A. In an unextended state, the sleeve 1410 is configured to closely contact the outside wall of a smaller diameter cup of a predetermined diameter. When a cup of a larger diameter is encountered, the material 900A will stretch, whereby the sleeve 1410 will readily conform to a larger diameter cup and remain in close contact therewith. Although a FIG. 18C shows a material 900A that is stretchable and elastic, the same concept of making the entire sleeve out of an extensible material is also envisioned. With the entire sleeve 1410 comprised of an extensible material, it is desirable to laminate an absorbent, nonwoven material to the entire inside surface of sleeve using known laminating techniques. Alternatively, strips or bands of a nonwoven material may be applied to the inside surface as described above with respect to FIG. 1. The nonwoven material may be of the type that includes a trapped or embedded super absorbent polymer, a super absorbent fiber or a cellulosic fiber of an air-laid or wet-laid type. Cellulosic fibers have the advantage of being recyclable, which is another advantage especially if the entire sleeve substrate is made from an extensible crepe.

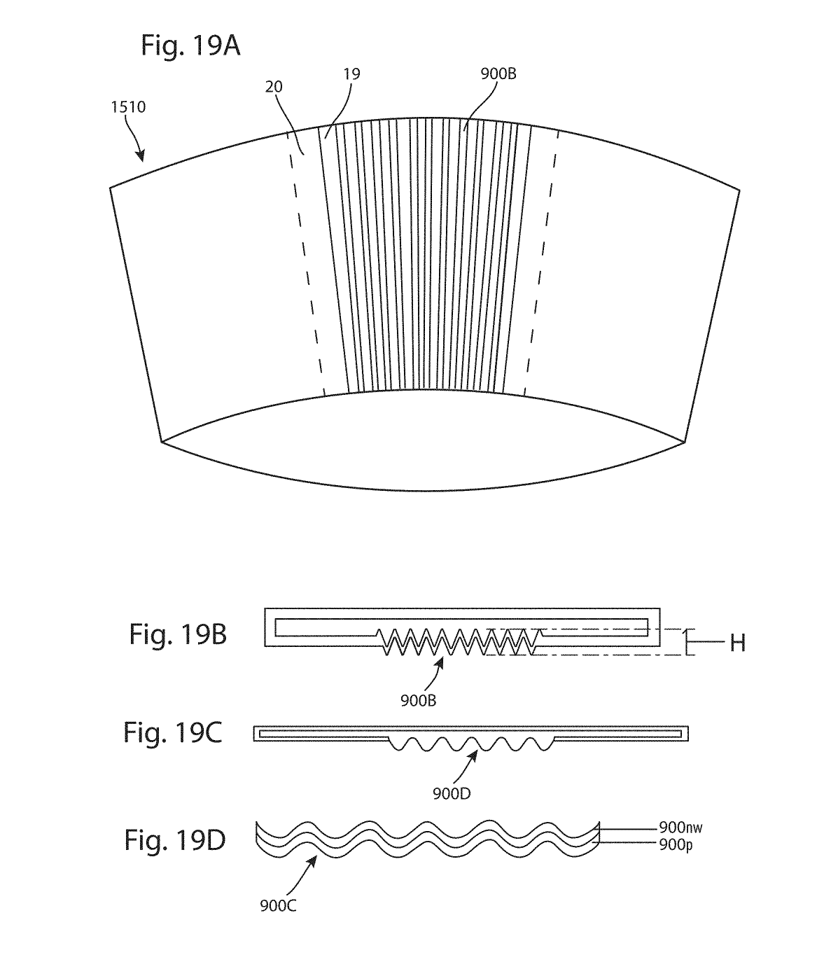

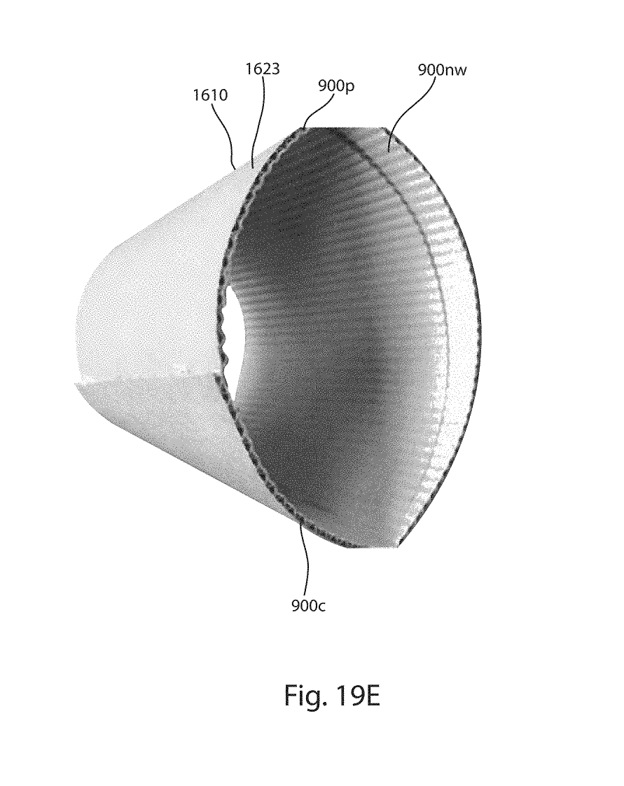

Another version of an extendable sleeve 1510 is shown in FIGS. 19A and 19B. There, it is seen that a section of the sleeve now comprises an integrated extendable section 900B that has been mechanically folded, scored and debossed in a manner akin to the bellows of an accordion. This special type of accordion-like folding can be accomplished with a paper or plastic sleeve substrate such that this version of an extendable sleeve is applicable to various embodiments of the invention. In FIG. 19A, the expandable section 900B can either be a paper material or a plastic material because the extendable material 900B is part of the sleeve that has one end 19 manufactured with the fold lines prior to attachment to the other end 20 of the sleeve 110. In other words, the extendable section 900B is an integral part of the sleeve, rather than a separate section that is bonded to the sleeve in the embodiment of FIG. 18A. Attachment of the end adjacent to the extendable section to the other end would be the same as previously described with respect to the sleeve shown in FIG. 1, using thermal bonding techniques or by adhesive attachment. In FIG. 19B, it is seen that the sharp folds have a total height “H”, which can be increased or decreased to provide the amount of expansion desired. The folds in an unexpanded state are preferably compressed such that the face of each fold touches the face of an adjacent fold. Alternatively, the folds may be slightly spaced apart from each other in a resting state. The thickness and the type of paper or plastic material that is used to form the sleeve of this version can be chosen such that an expansion of the folds will either be very resistive to expansion or readily expanded. FIG. 19B also shows that the folding of material 900B can be done in a manner such that the total height of the folds (amplitude) are split such that an equal amount of material in each fold extends between both surfaces of that part of the sleeve. Because the remainder of the sleeve will be in close contact against the outside cup wall, it is preferable to make the amplitude relatively small so that this section of the sleeve is also in close contact against the cup wall. In another form shown in FIG. 19C, the folds of the extendable section 900 can be that formed with a sinusoidal wave instead of the sharp, accordion-like folds shown in FIG. 19B. This expandable portion of the sleeve, whether the sleeve substrate is comprised of paper or plastic material, will remain in a compacted and folded position until expanded. Expansion will occur to the extent necessary to accommodate whatever outside diameter is encountered as the sleeve is pushed upwardly in close contact with the outside wall of a cup. Alternatively, the number of folds can be adjusted so that they completely expand into a planar state when the largest predetermined outside diameter is encountered.

FIG. 19D shows a portion of another type of expandable sleeve 900C. With this version, a paper layer of material 900p is first laminated to an absorbent material, such as non-woven layer 900nw and then both layers are simultaneously corrugated as a single substrate, such as an E or F flute corrugation profile, prior to die-cutting the sleeve blank. The nonwoven layer 900nw is a mat of an absorbent, nonwoven material attached to the paper layer using the laminating techniques described herein above. Alternatively, strips or bands of the absorbent, nonwoven material may be applied to the inside surface of layer 900p as described earlier above with respect to the embodiment shown in FIG. 1 at spaced apart locations near the top and bottom of the sleeve instead of fully covering the entire inside surface of layer 900p. The nonwoven material may be of the type that includes a trapped or embedded super absorbent polymer, a super absorbent fiber or a cellulosic fiber of an air-laid or wet-laid type. Because the entire laminated sleeve is fluted, the sleeve is capable of expansion when the flutes of the sleeve become flattened when the sleeve is applied about a circumference of a cup that is larger than the unexpanded circumference of the sleeve. In another form shown in FIG. 19E, the corrugated paper and absorbent material laminate 900C can be laminated to a flat paper substrate 1623 which forms an outer layer of an insulative and absorbent sleeve 1610 as described with regards to FIG. 19D. The absorbent material 900nw may cover the entire inner facing surface of the corrugated paper layer 900p, or could be applied in bands or other patterns. Production efficiencies may be obtained by corrugating the paper 900p and absorbent material 900nw together prior to laminating the outer paper layer 1623 to the corrugated laminate 900C.

In another embodiment of the present invention, a size adjustable sleeve may be provided through the use of a releasable adhesive on one end of the sleeve. In this embodiment the sleeve blank is sized to accommodate a predetermined cup diameter. If the sleeve is to be used with a cup of a smaller diameter than the predetermined cup diameter, the normal glue joint of the sleeve can be adapted to be readily undone such that the sleeve will have two loose ends. One of the loose ends can be re-wrapped about the outer surface of the sleeve so as to adjust and tighten the sleeve about a smaller diameter cup with the extra material being re-attached along the outside surface of the sleeve. In this version, an end of the sleeve is secured to the outside surface of the other end of the sleeve by a suitable releasable adhesive, such as that sold under the brand Geckskin™ or a “fugitive” type of adhesive. This adhesive allows one end of the sleeve to be detached from the outside surface of the other end of the sleeve so as to match the diameter of the user's cup. Instead of providing a typical adhesive strip glue strip area (See element 26 in FIG. 1) to permanently attach the ends of the sleeve together, the releasable adhesive glue strip area would be laterally wider and to the lateral extent that represents the full range of extension that will be required in order for the sleeve to adjust from the largest diameter to the smallest diameter. This embodiment permits an open end of the sleeve to be secured to the outside surface of the other sleeve end but when the sleeve size needs to be adjusted, the sleeve's end portion can be detached and then re-attached to the other end of sleeve within the wider glue region. In this way, the one sleeve end can be pulled from attachment with the outside surface of the other end of the sleeve to expand or contract the diameter of the sleeve to fit a larger or smaller diameter cup as the need dictates. This type of adhesive allows detachment and re-attachment of the sleeve end many times and can be applied to either a paper or plastic sleeve.

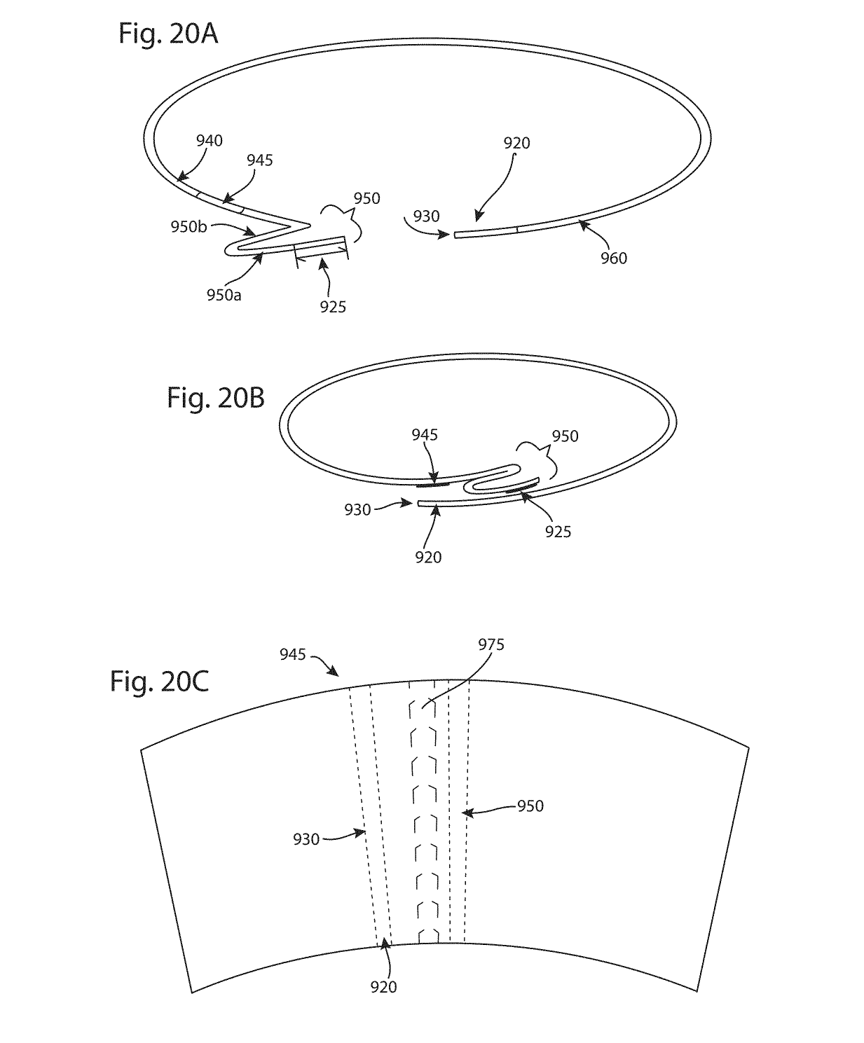

FIGS. 20A-20C show another embodiment of an extendable sleeve FIG. 20C shows the outside surface of the sleeve is vertically scored with a pair of laterally spaced perforations that form a vertically extending tear strip 975. When the tear strip 975 is removed from the sleeve, folded material 950 is exposed that expands the sleeve to accommodate larger diameter cups. In some instances, it may be desirable to provide additional, identical tear strip arrangements on the sleeve. In that way, the amount of stored material at each tear strip location can be minimized so that the sleeve will more closely contact the outside wall of a cup. FIGS. 20A and 20B show a top view of this embodiment of the sleeve in an unglued state. The lateral end 940 of the sleeve is comprised of the folded material 950 which is formed by two folds of material 950a, 950b, that are collapsed upon each other but available for later expansion. The one face of folded material 950a is provided with glue along area 925 at its end so that it can be glued to the inside surface of sleeve end 960, next to the area identified at 920 as grey shading, which is a glue application area. FIG. 20C shows sleeve end 960 glued to other sleeve end 940 at glue area 945 such that edge 930 does not extend past the glue area. Thus, the sleeve ends are overlapped before being attached together. When attached, face 950a of folded material 950 is glued to the inside surface of sleeve end 960 at its end 925 while the lateral-most part of sleeve end 960 is attached by glue area 920 to the outside surface of sleeve end 940 at glue area 945, thereby creating two spaced locations where the sleeve ends are glued together. When the tear strip 975 is removed, it allows the tucked and stored material 950 to be freed for expansion. This is possible because face 950a is still bonded to sleeve end 960 and is part of sleeve end 940 such that two folds 950a, 950b comprising the folded material 950 are free to be pulled apart and away from each other, thereby expanding the sleeve diameter to the extent of the combined lateral widths of the two folds of material.

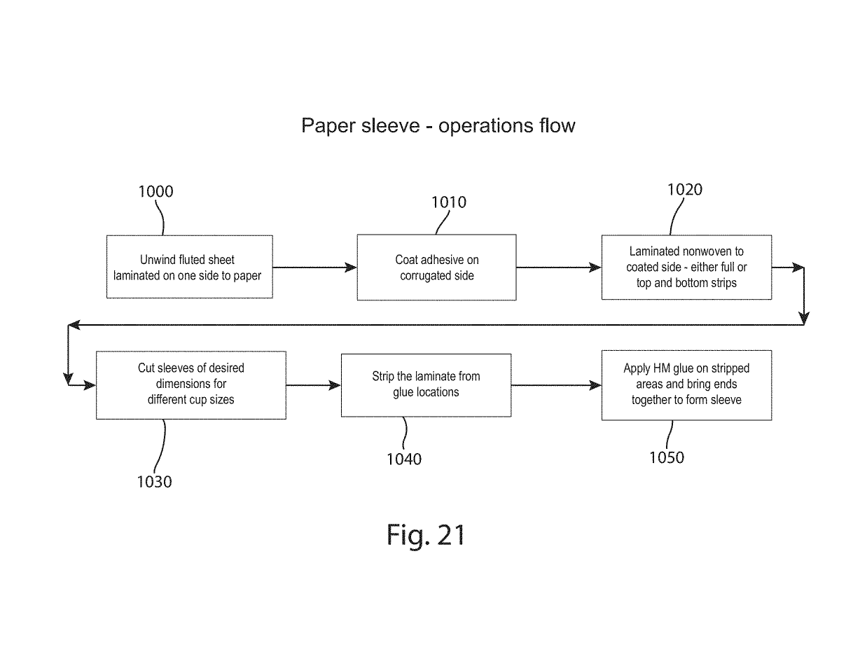

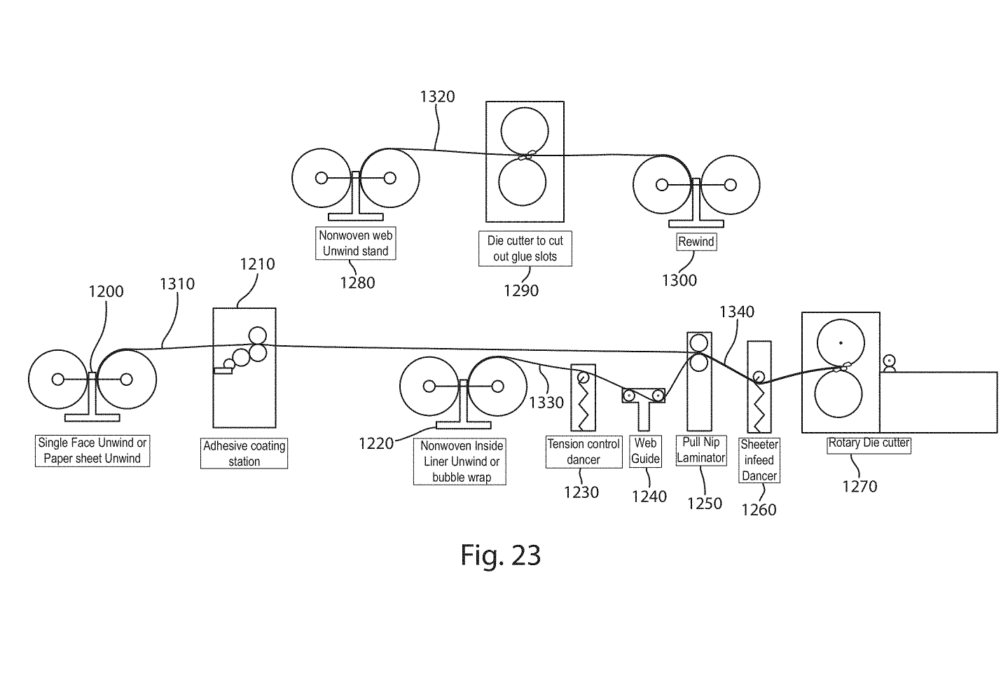

FIGS. 21-23 illustrate some examples of the processes for creating both the paper-based and film-based sleeves described herein. For example, as shown in FIG. 23, to form a paper sleeve having an absorbent material bonded to the sleeve, a web 1310 of fluted sheet on an unwind stand 1200 is unwound 1000 and transferred through an adhesive coating station 1210 to apply an adhesive to the corrugated side of the sheet in the desired locations 1010. Next, the absorbent material 1320, such as a non-woven material embedded with a SAP, is laminated to the corrugated side of the sheet at the adhesive locations 1020 using a pull nip laminator 1250. In one form, prior to being laminated to the fluted sheet, the non-woven fabric 1320 can be fed from an unwind stand 1280 through a die cutter 1290 to cut out glue slots so that when the fabric is laminated to the paper sheet, the slots line up with the glue area 26 of the blanks. After the glue slots are cut, the non-woven fabric 1320 is rewound on a rewind stand 1300. The inner layer 1330, such as non-woven fabric 1320 is then unwound from an unwind stand 1220 and routed through a web conditioning system, such as a tension control dancer 1230 and a web guide 1240 before traveling through the pull nip laminator 1250. The laminated material 1340 travels about a sheeter infeed dancer 1260 before blanks are cut 1030 from laminated material 1340 using a rotary die cutter 1270. Alternatively, a flat punch could be used to cut the blanks from sheets of laminated material. If glue slots are not already provided, the non-woven material may then be stripped from the glue locations 1040. The blanks may then be formed into sleeves by applying glue on the stripped areas and bringing the blank ends together 1050, such as disclosed in US 20150314974.

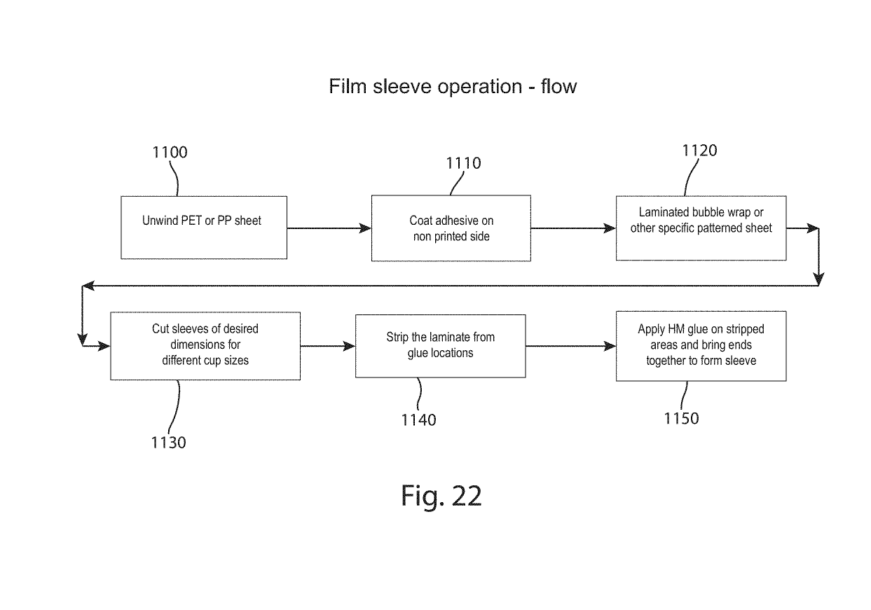

The process for creating a transparent sleeve described herein is similar to the process for the paper sleeve. For example, as shown in FIGS. 22 and 23, a web of PET or PP film 1310 on an unwind stand 1200 is unwound 1100 and transferred through an adhesive coating station 1210 to apply 1110 an adhesive to one side of the film 1310. Next, the bubble wrap or other inner layer material, is laminated 1120 to the adhesive coated side of the film 1310 using a pull nip laminator 1250. The bubble wrap or other inner layer 1330 is then unwound from an unwind stand 1220 and routed through a web conditioning system, such as a tension control dancer 1230 and a web guide 1240 before traveling through the pull nip laminator 1250. The laminated material 1340 travels about a sheeter infeed dancer 1260 before blanks are cut 1130 from laminated material using a rotary die cutter 1270. The inner bubble layer of the laminate may then be stripped or abraded or melted and compressed under heat and pressure from the glue locations 1140. The blanks may then be formed into sleeves by applying hot melt glue or heat seal or ultrasonic seal on the stripped areas and bringing the ends of the blanks together 1150.

Those skilled in the art will recognize that a wide variety of modifications, alterations, and combinations can be made with respect to the above described embodiments without departing from the spirit and scope of the invention, and that such modifications, alterations, and combinations, are to be viewed as being within the scope of the invention.

What is claimed is:

1. A sleeve for being positioned about an outside surface of a container for capturing condensate thereon, the sleeve comprising:
a first layer sized and configured to be disposed about the outside surface of the container; a non-absorbent inner facing surface of the first layer; and
one or more non-absorbent entrapment features configured to be in contact with the outside surface of the container and to form at least one void formed between the container, the one or more entrapment features, and the non-absorbent inner facing surface of the first layer, such that the one or more entrapment features are configured to capture the condensate disposed on the outside surface of the container by collecting and retaining the condensate in the at least one void.

2. The sleeve of claim 1, further comprising a second layer bonded to an outer facing surface of the first layer.

3. The sleeve of claim 2, wherein the first layer and second layer are of a polymer material.

4. The sleeve of claim 1, wherein the one or more entrapment features are arranged to form a repeating pattern of hexagonally-shaped voids.

5. The sleeve of claim 1, wherein the one or more entrapment features are arranged to form one or more alphanumeric characters.

6. The sleeve of claim 5, wherein the alphanumeric characters are at least one of the letters H, J, K, M, N, U, V, W, X, and Y.

7. The sleeve of claim 2, wherein the one or more entrapment features are formed by one or more air-filled, enclosed compartments between the outer facing surface of the first layer and the inner facing surface of the second layer.

8. The sleeve of claim 7, wherein the air-filled, enclosed compartments are arranged in a plurality of rows for extending about the container outside surface.

9. The sleeve of claim 7, wherein the air-filled, enclosed compartments comprise at least one gap therebetween to allow condensate to descend between the air-filled, enclosed compartments through the gap.

10. The sleeve of claim 2, wherein the second layer is of a transparent polymer material.

11. The sleeve of claim 2, wherein the second layer is of a paper material.

12. The sleeve of claim 11, wherein the second layer is formed of a single-face corrugated paper material.

13. The sleeve of claim 1, wherein the one or more entrapment features are arranged to form a repeating pattern.

14. The sleeve of claim 1, wherein the first layer is of a fibrous material and the inner facing surface is coated with a water-resistant material, and the one or more entrapment features are formed by one of embossing and debossing.

15. The sleeve of claim 1, wherein the one or more entrapment features are arranged to form one or more non-linear channels through which the condensate may be directed.

16. The sleeve of claim 15, wherein the one or more non-linear channels form at least one tortuous path having multiple direction changes through which the condensate may be directed.

17. A method of making a sleeve for capturing condensate disposed on an outside surface of a beverage container, the method comprising:
advancing a first web of a polymer film through an adhesive coating station;
applying an adhesive to one side of the first web while advancing the first web through the adhesive coating station;
advancing a second web of material through a laminating station, the second web of material having a non-absorbent side, wherein the non-absorbent side includes one or more non-absorbent entrapment features configured to form at least one void between the container, the one or more entrapment features, and the non-absorbent side of the second web of material, wherein the one or more entrapment features are configured to capture the condensate disposed on the outside surface of the container and to collect and retain the condensate in the void;
laminating the second web of material to the first web as the first and second webs are advanced through the laminating station to form a laminated material; and
cutting the laminated material into a plurality of blanks; each blank sized and configured to be disposed about a beverage container.

18. The method of claim 17, wherein the blanks have opposing end portions and the method further comprises:
bonding the opposing end portions of the blank together to form a sleeve configured to be disposed about a beverage container.

19. The method of claim 18, further comprising applying an adhesive to at least one of the end portions at a predetermined glue location prior to bonding the opposing end portions together.

20. The method of claim 18, wherein bonding the opposing end portions of the blank together comprises one of heat sealing and ultrasonically sealing the opposing end portions together.

21. The method of claim 17, wherein the second web of material is of a polymer film material.
